(19) United States
(12) Patent Application Publication
(10) Pub. No.: US 2025/0220233 A1
(43) Pub. Date: Jul. 3, 2025

(54) ENCODING DEVICE, DECODING DEVICE, ENCODING METHOD, AND DECODING METHOD

(71) Applicant: Panasonic Intellectual Property Corporation of America, Torrance, CA (US)

(72) Inventors: Toshiyasu SUGIO, Osaka (JP); Noritaka IGUCHI, Osaka (JP); Takahiro NISHI, Nara (JP); Chong Soon LIM, Singapore (SG); Zheng WU, Singapore (SG); Han Boon TEO, Singapore (SG); Keng Liang LOI, Singapore (SG); Chung Dean HAN, Johor Bahru (MY); Farman DUMANOV, Singapore (SG)

(21) Appl. No.: 19/085,200

(22) Filed: Mar. 20, 2025

Related U.S. Application Data
(63) Continuation of application No. PCT/JP2023/035163, filed on Sep. 27, 2023.
(60) Provisional application No. 63/465,065, filed on May 9, 2023.
(60) Provisional application No. 63/412,625, filed on Oct. 3, 2022.

(51) Int. Cl. H04N 19/597; G06T 9/00; H04N 19/13; H04N 19/136; H04N 19/184

(52) U.S. Cl. CPC H04N 19/597; G06T 9/001; H04N 19/13; H04N 19/136; H04N 19/184

(57) ABSTRACT

An encoding device includes memory and a circuit accessible to the memory. In operation, the circuit: encodes first vertex information, second vertex information, and third vertex information into a bitstream, the first vertex information indicating a position of a first vertex of a first triangle, the second vertex information indicating a position of a second vertex of the first triangle, and the third vertex information indicating a position of a third vertex of the first triangle; and encodes angle information into the bitstream, the angle information indicating one or more angles used for identifying a position of a fourth vertex of a second triangle by reference to the first triangle, the second triangle being a triangle that shares a common side with the first triangle and is on the same place as the first triangle.

### CROSS REFERENCE TO RELATED APPLICATIONS

This is a continuation application of PCT International Application No. PCT/JP2023/035163 filed on Sep. 27, 2023, designating the United States of America, which is based on and claims priority of U.S. Provisional Patent Application No. 63/412,625 filed on Oct. 3, 2022 and U.S. Provisional Patent Application No. 63/465,065 filed on May 9, 2023. The entire disclosures of the above-identified applications, including the specifications, drawings and claims are incorporated herein by reference in their entirety.

### FIELD

The present disclosure relates to, for example, an encoding device.

### BACKGROUND

PTL 1 proposes a method and a device for encoding and decoding three-dimensional mesh data.

### CITATION LIST

### Patent Literature

PTL 1: Japanese Unexamined Patent Application Publication No. 2006-187015

### SUMMARY

### Technical Problem

There are demands for further improvement in processing of encoding three-dimensional data and the like. An object of the present disclosure is to improve processing of encoding three-dimensional data and the like.

### Solution to Problem

An encoding device according to one aspect of the present disclosure comprising: memory; and a circuit accessible to the memory, wherein in operation, the circuit: encodes first vertex information, second vertex information, and third vertex information into a bitstream, the first vertex information indicating a position of a first vertex of a first triangle, the second vertex information indicating a position of a second vertex of the first triangle, the third vertex information indicating a position of a third vertex of the first triangle; and encodes angle information into the bitstream, the angle information indicating one or more angles used for identifying a position of a fourth vertex of a second triangle by reference to the first triangle, the second triangle being a triangle that shares a common side with the first triangle and is on a same plane as the first triangle.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another to the configuration example of the bitstream according embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a conceptual diagram illustrating examples of a geometry map, a texture map, and a relationship between the geometry map and the texture map.

FIG. 27 is a flow chart illustrating an example of encoding processing according to the embodiment.

FIG. 28 is a flow chart illustrating a specific example of encoding processing according to the embodiment.

FIG. 29 is a flow chart illustrating another specific example of encoding processing according to the embodiment.

FIG. 30 is a conceptual diagram illustrating examples of two angles according to the embodiment.

FIG. 31 is a conceptual diagram illustrating other examples of two angles according to the embodiment.

FIG. 32 is a conceptual diagram illustrating yet other examples of two angles according to the embodiment.

FIG. 33 is a block diagram illustrating a configuration example of a V3C-compliant encoding device.

FIG. 34 is a block diagram illustrating another configuration example of a V3C-compliant encoding device.

FIG. 35 is a conceptual diagram illustrating an example of a position of a syntax element of an angle in a bitstream.

FIG. 36 is a conceptual diagram illustrating another example of a position of a syntax element of an angle in a bitstream.

FIG. 37 is a conceptual diagram illustrating an example of a position of a syntax element of an angle in a V3C sample stream.

FIG. 38 is a conceptual diagram illustrating another example of a position of a syntax element of an angle in a V3C sample stream.

FIG. 39 is a conceptual diagram illustrating yet another example of a position of a syntax element of an angle in a V3C sample stream.

FIG. 40 is a syntax diagram illustrating a syntax structure example of vertex information with respect to a plurality of vertexes in a case where a prediction mode is individually derived.

FIG. 41 is a syntax diagram illustrating a syntax structure example of vertex information with respect to one vertex in a case where a prediction mode is individually derived.

FIG. 42 is a syntax diagram illustrating another syntax structure example of vertex information with respect to one vertex in a case where a prediction mode is individually derived.

FIG. 43 is a syntax diagram illustrating a syntax structure example of vertex information with respect to a plurality of vertexes in a case where a prediction mode is derived from a corresponding vertex on a geometry map.

FIG. 44 is a syntax diagram illustrating a syntax structure example of vertex information with respect to one vertex in a case where a prediction mode is derived from a corresponding vertex on a geometry map.

FIG. 45 is a syntax diagram illustrating another syntax structure example of vertex information with respect to one vertex in a case where a prediction mode is derived from a corresponding vertex on a geometry map.

FIG. 46 is a table diagram illustrating an example of a table used in prediction of an angle.

FIG. 47 is a table diagram illustrating another example of a table used in prediction of an angle.

FIG. 48 is a conceptual diagram illustrating an example of prediction using an angle with respect to a vertex of a previous triangle.

FIG. 49 is a conceptual diagram illustrating an example of prediction using an angle with respect to a vertex of a previous mesh.

FIG. 50 is a block diagram illustrating a configuration example of an encoding device according to the embodiment.

FIG. 51 is a flow chart illustrating an example of decoding processing according to the embodiment.

FIG. 52 is a flow chart illustrating a specific example of the decoding processing according to the embodiment.

FIG. 53 is a flow chart illustrating another specific example of the decoding processing according to the embodiment.

FIG. 54 is a block diagram illustrating a configuration example of a V3C-compliant decoding device.

FIG. 55 is a block diagram illustrating another configuration example of a V3C-compliant decoding device.

FIG. 56 is a table diagram illustrating an example of a look-up table of a sine function and a cosine function.

FIG. 57 is a block diagram illustrating a configuration example of a decoding device according to the embodiment.

FIG. 58 is a flow chart illustrating an example of basic encoding processing according to the embodiment.

FIG. 59 is a flow chart illustrating an example of basic decoding processing according to the embodiment.

FIG. 60 is a block diagram illustrating yet another configuration example of the encoding device according to the embodiment.

FIG. 61 is a block diagram illustrating yet another configuration example of the decoding device according to the embodiment.

### DESCRIPTION OF EMBODIMENT

### Introduction

For example, a three-dimensional mesh is used in computer graphic images. A three-dimensional mesh is constituted of vertex information indicating a position of each of a plurality of vertexes in a three-dimensional space, connection information indicating a connection relationship among the plurality of vertexes, and attribute information indicating an attribute of each vertex or each face. Each face is constructed according to the connection relationship among a plurality of vertexes. Various computer graphic images can be expressed by such three-dimensional meshes.

In addition, encoding of efficient and decoding three-dimensional meshes are anticipated for the purpose of transmission and accumulation of the three-dimensional meshes. For example, in order to encode vertex information in an efficient manner, an encoding device reduces a coding amount by predicting position information of a vertex being an encoding object using position information of an encoded vertex and encoding a difference with respect to the prediction.

In addition, a texture of each surface on a geometry map of a three-dimensional space may be defined on a texture map of a two-dimensional plane. In this case, a vertex on the texture map of a two-dimensional plane is defined for a vertex on the geometry map of a three-dimensional space. Furthermore, not only vertex information indicating a position of the vertex on the geometry map but also vertex information indicating a position of the vertex on the texture map may be encoded.

For example, in order to encode vertex information in an efficient manner including vertex information indicating the position of a vertex on a texture map, an encoding device reduces a code amount by predicting position information of a vertex being an encoding object using position information of an encoded vertex and encoding a difference with respect to the prediction.

However, predicting the position of a vertex being an encoding object using position information of an encoded vertex in a three-dimensional space is not easy and a difference with respect to the prediction may increase. In other words, the code amount may possibly increase.

In view of the above, an encoding device according to Example 1 includes memory and a circuit accessible to the memory. In operation, the circuit: encodes first vertex information, second vertex information, and third vertex information into a bitstream, the first vertex information indicating a position of a first vertex of a first triangle, the second vertex information indicating a position of a second vertex of the first triangle, the third vertex information indicating a position of a third vertex of the first triangle; and encodes angle information into the bitstream, the angle information indicating one or more angles used for identifying a position of a fourth vertex of a second triangle by reference to the first triangle, the second triangle being a triangle that shares a common side with the first triangle and is on a same plane as the first triangle.

Accordingly, angle information may possibly be encoded as information used for identifying the position of the fourth vertex. For example, it can be assumed that the value of each angle indicated by angle information is included in a certain range such as from 0 degrees to 180 degrees. Therefore, an increase in a code amount may possibly be suppressed.

Moreover, an encoding device according to Example 2 may be the encoding device according to Example 1, in which each of the first vertex, the second vertex, the third vertex, and the fourth vertex is a vertex on a geometry map of a three-dimensional space.

Accordingly, angle information used for identifying a position of the fourth vertex of the second triangle by reference to the first triangle that includes the first vertex, the second vertex, and the third vertex on the geometry map of the three-dimensional space may possibly be encoded. Therefore, an increase in a code amount may possibly be suppressed with respect to geometry information of the three-dimensional space.

Furthermore, an encoding device according to Example 3 may be the encoding device according to Example 1, in which each of the first vertex, the second vertex, the third vertex, and the fourth vertex is a vertex on a texture map of a two-dimensional plane.

Accordingly, angle information used for identifying a position of the fourth vertex of the second triangle by reference to the first triangle that includes the first vertex, the second vertex, and the third vertex on the texture map of the two-dimensional plane may possibly be encoded. Therefore, an increase in a code amount may possibly be suppressed with respect to texture information of the two-dimensional plane.

Moreover, an encoding device according to Example 4 may be the encoding device according to any one of Example 1 to Example 3, in which the angle information is encoded in accordance with an entropy coding scheme.

Accordingly, an entropy coding scheme may possibly be applied to angle information. Therefore, a code amount of angle information may possibly be reduced.

Furthermore, an encoding device according to Example 5 may be the encoding device according to any one of Example 1 to Example 4, in which the angle information indicates the one or more angles, based on one or more prediction errors between the one or more angles and one or more predicted angles predicted for the one or more angles by reference to previously encoded information.

Accordingly, angle information indicating one or more angles based on one or more prediction errors may possibly be encoded. Each of the one or more prediction errors may possibly be smaller than the one or more angles. Therefore, a code amount of angle information may possibly be reduced.

Moreover, an encoding device according to Example 6 may be the encoding device according to any one of Example 1 to Example 5, in which each of the one or more angles has a value in a range from 0 degrees to 180 degrees.

Accordingly, angle information indicating one or more angles based on a value in a range from 0 degrees to 180 degrees may possibly be encoded. Therefore, an increase in a code amount may possibly be suppressed.

Furthermore, an encoding device according to Example 7 may be the encoding device according to Example 3, in which the circuit: selects a processing mode for the position of the fourth vertex from a plurality of processing modes including an angle mode; and encodes the angle information into the bitstream when the angle mode is selected as the processing mode for the position of the fourth vertex.

Accordingly, the processing mode of the position of the fourth vertex may possibly be adaptively selected. Therefore, the position of the fourth vertex may possibly be adaptively processed.

Moreover, an encoding device according to Example 8 may be the encoding device according to Example 7, in which the circuit selects the processing mode for the position of the fourth vertex by reference to a corresponding processing mode for a position of a corresponding vertex that is a vertex corresponding to the fourth vertex on a geometry map of a three-dimensional space.

Accordingly, a processing mode suitable for the position of the fourth vertex on the texture map may possibly be selected according to the corresponding processing mode for the position of a corresponding vertex on the geometry map. In addition, an increase in a code amount with respect to the processing mode may possibly be suppressed.

Furthermore, an encoding device according to Example 9 may be the encoding device according to Example 8, in which the circuit: encodes a flag into a header of the bitstream, the flag indicating whether to select the processing mode for the position of the fourth vertex by reference to the corresponding processing mode for the position of the corresponding vertex; and selects the processing mode for the position of the fourth vertex by reference to the corresponding processing mode for the position of the corresponding vertex when the flag indicates that the corresponding processing mode for the position of the corresponding vertex is to be referred to.

Accordingly, whether to select the processing mode for the texture map according to the corresponding processing mode for the geometry map may possibly be switched according to the flag. Therefore, whether to select the processing mode for the texture map according to the corresponding processing mode for the geometry map may possibly be adaptively switched.

Moreover, an encoding device according to Example 10 may be the encoding device according to any one of Example 3 and Example 7 to Example 9, in which the angle information indicates the one or more angles, based on one or more corresponding angles used for identifying a position of a corresponding vertex that is a vertex corresponding to the fourth vertex on a geometry map of a three-dimensional space.

Accordingly, angle information that is shared between the geometry map and the texture map may possibly be encoded. Therefore, an increase in a code amount may possibly be suppressed.

Furthermore, an encoding device according to Example 11 may be the encoding device according to any one of Example 3 and Example 7 to Example 9, in which the angle information indicates the one or more angles, based on one or more errors between the one or more angles and one or more corresponding angles used for identifying a position of a corresponding vertex that is a vertex corresponding to the fourth vertex on a geometry map of a three-dimensional space.

Accordingly, angle information indicating one or more angles based on one or more errors between the geometry map and the texture map may possibly be encoded. Each of the one or more errors may possibly be smaller than the one or more angles. Therefore, a code amount of angle information may possibly be reduced.

Moreover, an encoding device according to Example 12 may be the encoding device according to any one of Example 1 to Example 11, in which the one or more angles are two angles.

Accordingly, angle information indicating two angles may possibly be encoded as information used for identifying the position of the fourth vertex. In addition, the position of the fourth vertex may possibly be identified according to only two angles. Therefore, an increase in a code amount may possibly be suppressed.

Furthermore, an encoding device according to Example 13 may be the encoding device according to any one of Example 1 to Example 11, in which the one or more angles are one angle, and the circuit further encodes distance information indicating a distance between a vertex of the one angle and the fourth vertex.

Accordingly, angle information indicating one angle and distance information indicating a distance may possibly be encoded as information used for identifying the position of the fourth vertex. It can be assumed that the value of the one angle is included in a certain range such as from 0 degrees to 180 degrees. Therefore, an increase in a code amount may possibly be suppressed with respect to one parameter among two parameters used for identifying the position of the fourth vertex.

A decoding device according to Example 14 includes memory and a circuit accessible to the memory. In operation, the circuit: decodes first vertex information, second vertex information, and third vertex information from a bitstream, the first vertex information indicating a position of a first vertex of a first triangle, the second vertex information indicating a position of a second vertex of the first triangle, the third vertex information indicating a position of a third vertex of the first triangle; and decodes angle information from the bitstream, the angle information indicating one or more angles used for identifying a position of a fourth vertex of a second triangle by reference to the first triangle, the second triangle being a triangle that shares a common side with the first triangle and is on a same plane as the first triangle.

Accordingly, angle information may possibly be decoded as information used for identifying the position of the fourth vertex. For example, it can be assumed that the value of each angle indicated by angle information is included in a certain range such as from 0 degrees to 180 degrees. Therefore, an increase in a code amount may possibly be suppressed.

Moreover, a decoding device according to Example 15 may be the decoding device according to Example 14, in which each of the first vertex, the second vertex, the third vertex, and the fourth vertex is a vertex on a geometry map of a three-dimensional space.

Accordingly, angle information used for identifying a position of the fourth vertex of the second triangle by reference to the first triangle that includes the first vertex, the second vertex, and the third vertex on the geometry map of the three-dimensional space may possibly be decoded. Therefore, an increase in a code amount may possibly be suppressed with respect to geometry information of the three-dimensional space.

Furthermore, a decoding device according to Example 16 may be the decoding device according to Example 14, in which each of the first vertex, the second vertex, the third vertex, and the fourth vertex is a vertex on a texture map of a two-dimensional plane.

Accordingly, angle information used for identifying a position of the fourth vertex of the second triangle by reference to the first triangle that includes the first vertex, the second vertex, and the third vertex on the texture map of the two-dimensional plane may possibly be decoded. Therefore, an increase in a code amount may possibly be suppressed with respect to texture information of the two-dimensional plane.

Moreover, a decoding device according to Example 17 may be the decoding device according to any one of Example 14 to Example 16, in which the angle information is decoded in accordance with an entropy coding scheme.

Accordingly, an entropy coding scheme may possibly be applied to angle information. Therefore, a code amount of angle information may possibly be reduced.

Furthermore, a decoding device according to Example 18 may be the decoding device according to any one of Example 14 to Example 17, in which the angle information indicates the one or more angles, based on one or more prediction errors between the one or more angles and one or more predicted angles predicted for the one or more angles by reference to previously decoded information.

Accordingly, angle information indicating one or more angles based on one or more prediction errors may possibly be decoded. Each of the one or more prediction errors may possibly be smaller than the one or more angles. Therefore, a code amount of angle information may possibly be reduced.

Moreover, a decoding device according to Example 19 may be the decoding device according to any one of Example 14 to Example 18, in which each of the one or more angles has a value in a range from 0 degrees to 180 degrees.

Accordingly, angle information indicating one or more angles based on a value in a range from 0 degrees to 180 degrees may possibly be decoded. Therefore, an increase in a code amount may possibly be suppressed.

Furthermore, a decoding device according to Example 20 may be the decoding device according to Example 16, in which the circuit: selects a processing mode for the position of the fourth vertex from a plurality of processing modes including an angle mode; and decodes the angle information from the bitstream when the angle mode is selected as the processing mode for the position of the fourth vertex.

Accordingly, the processing mode of the position of the fourth vertex may possibly be adaptively selected. Therefore, the position of the fourth vertex may possibly be adaptively processed.

Moreover, a decoding device according to Example 21 may be the decoding device according to Example 20, in which the circuit selects the processing mode for the position of the fourth vertex by reference to a corresponding processing mode for a position of a corresponding vertex that is a vertex corresponding to the fourth vertex on a geometry map of a three-dimensional space.

Accordingly, a processing mode suitable for the position of the fourth vertex on the texture map may possibly be selected according to the corresponding processing mode for the position of a corresponding vertex on the geometry map. In addition, an increase in a code amount with respect to the processing mode may possibly be suppressed.

Furthermore, a decoding device according to Example 22 may be the decoding device according to Example 21, in which the circuit: decodes a flag from a header of the bitstream, the flag indicating whether to select the processing mode for the position of the fourth vertex by reference to the corresponding processing mode for the position of the corresponding vertex; and selects the processing mode for the position of the fourth vertex by reference to the corresponding processing mode for the position of the corresponding vertex when the flag indicates that the corresponding processing mode for the position of the corresponding vertex is to be referred to.

Accordingly, whether to select the processing mode for the texture map according to the corresponding processing mode for the geometry map may possibly be switched according to the flag. Therefore, whether to select the processing mode for the texture map according to the corresponding processing mode for the geometry map may possibly be adaptively switched.

Moreover, a decoding device according to Example 23 may be the decoding device according to any one of Example 16 and Example 20 to Example 22, in which the angle information indicates the one or more angles, based on one or more corresponding angles used for identifying a position of a corresponding vertex that is a vertex corresponding to the fourth vertex on a geometry map of a three-dimensional space.

Accordingly, angle information that is shared between the geometry map and the texture map may possibly be decoded. Therefore, an increase in a code amount may possibly be suppressed.

Furthermore, a decoding device according to Example 24 may be the decoding device according to any one of Example 16 and Example 20 to Example 22, in which the angle information indicates the one or more angles, based on one or more errors between the one or more angles and one or more corresponding angles used for identifying a position of a corresponding vertex that is a vertex corresponding to the fourth vertex on a geometry map of a three-dimensional space.

Accordingly, angle information indicating one or more angles based on one or more errors between the geometry map and the texture map may possibly be decoded. Each of the one or more errors may possibly be smaller than the one or more angles. Therefore, a code amount of angle information may possibly be reduced.

Moreover, a decoding device according to Example 25 may be the decoding device according to any one of Example 14 to Example 24, in which the one or more angles are two angles.

Accordingly, angle information indicating two angles may possibly be decoded as information used for identifying the position of the fourth vertex. In addition, the position of the fourth vertex may possibly be identified according to only two angles. Therefore, an increase in a code amount may possibly be suppressed.

Furthermore, a decoding device according to Example 26 may be the decoding device according to any one of Example 14 to Example 24, in which the one or more angles are one angle, and the circuit further decodes distance information indicating a distance between a vertex of the one angle and the fourth vertex.

Accordingly, angle information indicating one angle and distance information indicating a distance may possibly be decoded as information used for identifying the position of the fourth vertex. It can be assumed that the value of the one angle is included in a certain range such as from 0 degrees to 180 degrees. Therefore, an increase in a code amount may possibly be suppressed with respect to one parameter among two parameters used for identifying the position of the fourth vertex.

An encoding method according to Example 27 includes: encoding first vertex information, second vertex information, and third vertex information into a bitstream, the first vertex information indicating a position of a first vertex of a first triangle, the second vertex information indicating a position of a second vertex of the first triangle, the third vertex information indicating a position of a third vertex of the first triangle; and encoding angle information into the bitstream, the angle information indicating one or more angles used for identifying a position of a fourth vertex of a second triangle by reference to the first triangle, the second triangle being a triangle that shares a common side with the first triangle and is on a same plane as the first triangle.

Accordingly, angle information may possibly be encoded as information used for identifying the position of the fourth vertex. For example, it can be assumed that the value of each angle indicated by angle information is included in a certain range such as from 0 degrees to 180 degrees. Therefore, an increase in a code amount may possibly be suppressed.

A decoding method according to Example 28 includes: decoding first vertex information, second vertex information, and third vertex information from a bitstream, the first vertex information indicating a position of a first vertex of a first triangle, the second vertex information indicating a position of a second vertex of the first triangle, the third vertex information indicating a position of a third vertex of the first triangle; and decoding angle information from the bitstream, the angle information indicating one or more angles used for identifying a position of a fourth vertex of a second triangle by reference to the first triangle, the second triangle being a triangle that shares a common side with the first triangle and is on a same plane as the first triangle.

Accordingly, angle information may possibly be decoded as information used for identifying the position of the fourth vertex. For example, it can be assumed that the value of each angle indicated by angle information is included in a certain range such as from 0 degrees to 180 degrees. Therefore, an increase in a code amount may possibly be suppressed.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and Terms

The following expressions and terms will be used herein.

### (1) Three-Dimensional Mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

### (2) Vertex Information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as “geometry”. In addition, vertex information may also be expressed as position information.

### (3) Connection Information

Connection information is information indicating a connection between vertexes. For example, connection information indicates a connection for constructing a face or an edge of a three-dimensional mesh. Connection information may be expressed as “connectivity”. In addition, connection information may also be expressed as face information.

### (4) Attribute Information

Attribute information is information indicating an attribute of a vertex or a face. For example, attribute information indicates an attribute such as a color, an image, a normal vector, and the like associated with a vertex or a face. Attribute information may be expressed as “texture”.

### (5) Face

A face is an element that constitutes a three-dimensional mesh. Specifically, a face is a polygon on a plane in a three-dimensional space. For example, a face can be determined as a triangle in the three-dimensional space.

### (6) Plane

A plane is a two-dimensional plane in a three-dimensional space. For example, a polygon is formed on a plane and a plurality of polygons are formed on a plurality of planes.

### (7) Bitstream

A bitstream corresponds to encoded information. A bitstream can also be expressed as a stream, an encoded bitstream, a compressed bitstream, or an encoded signal.

### (8) Encoding and Decoding

The expression “encode” may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression “decode” may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

### (9) Ordinal Numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### <Three-Dimensional Mesh>

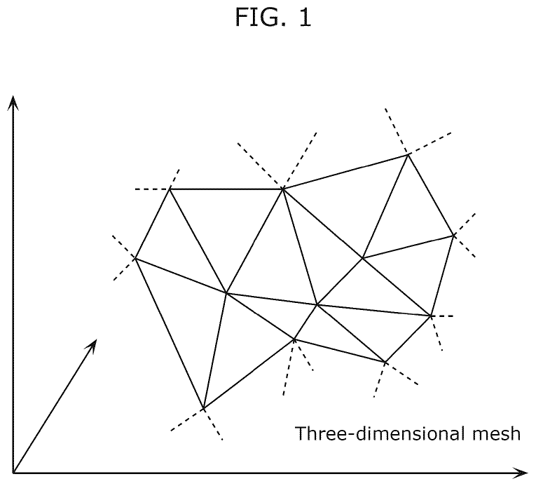

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

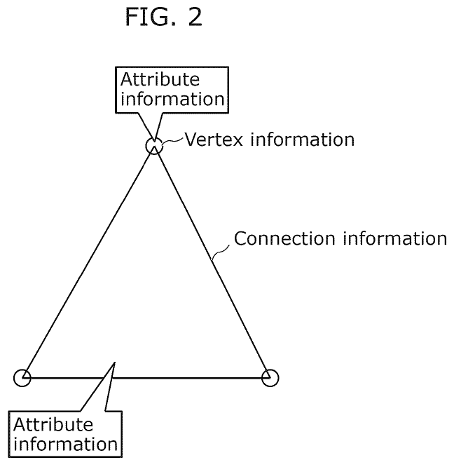

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as “attribute per point”. Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an “attribute map”. In addition, information indicating mapping between a face and a two-dimensional image may be associated with the face as attribute information. Such information indicating mapping may be expressed as mapping information, vertex information of a texture image, or an “attribute UV coordinate”.

Furthermore, information on a color, an image, a moving image, and the like to be used as attribute information may be expressed as “parametric space”.

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

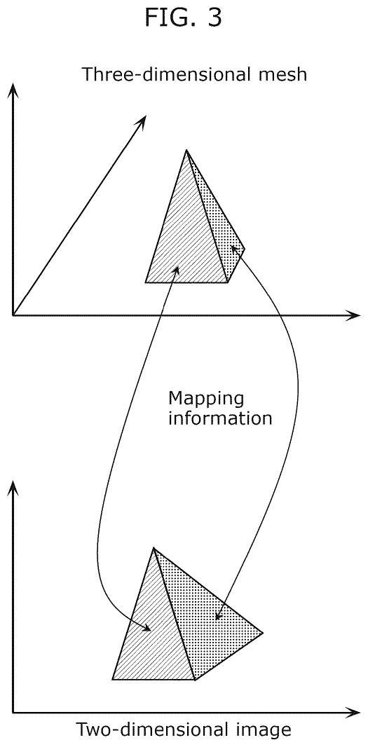

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### <System Configuration>

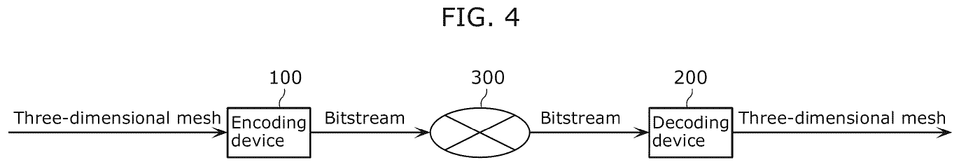

FIG. 4 is a block diagram illustrating a configuration example of an encoding/decoding system according to the present embodiment. In FIG. 4, the encoding/decoding system includes encoding device 100 and decoding device 200.

For example, device 100 acquires a encoding three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### <Encoding Device>

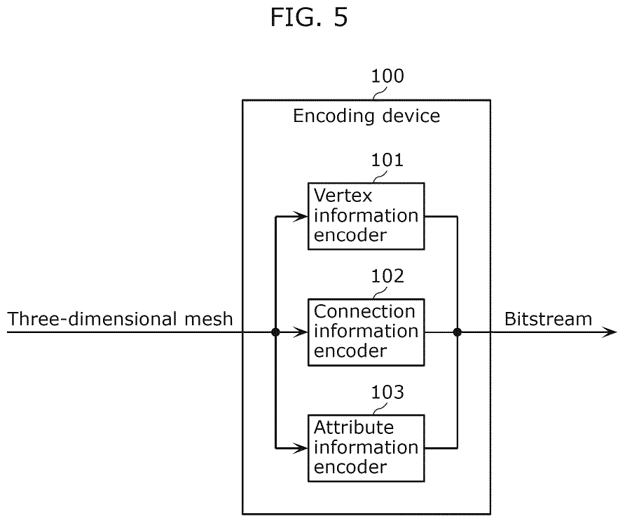

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

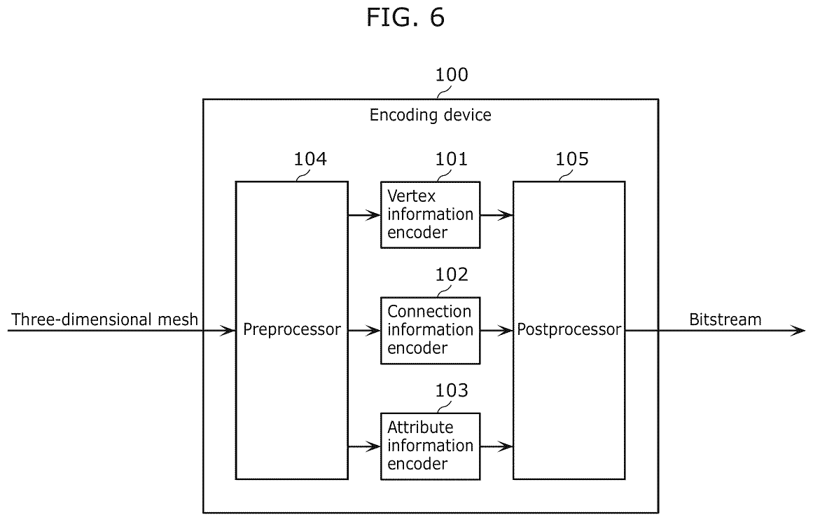

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### <Decoding Device>

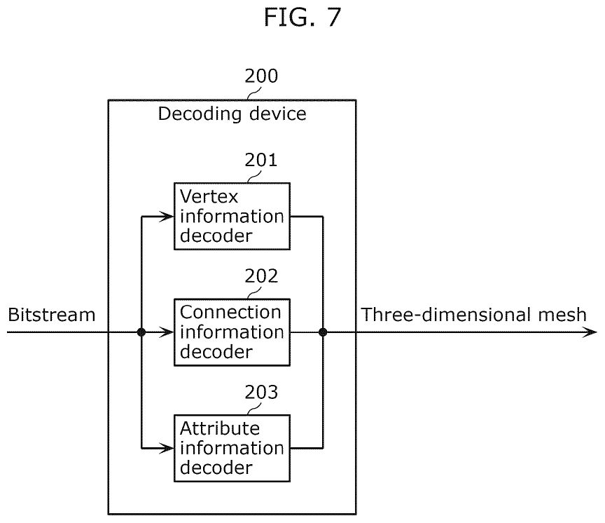

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

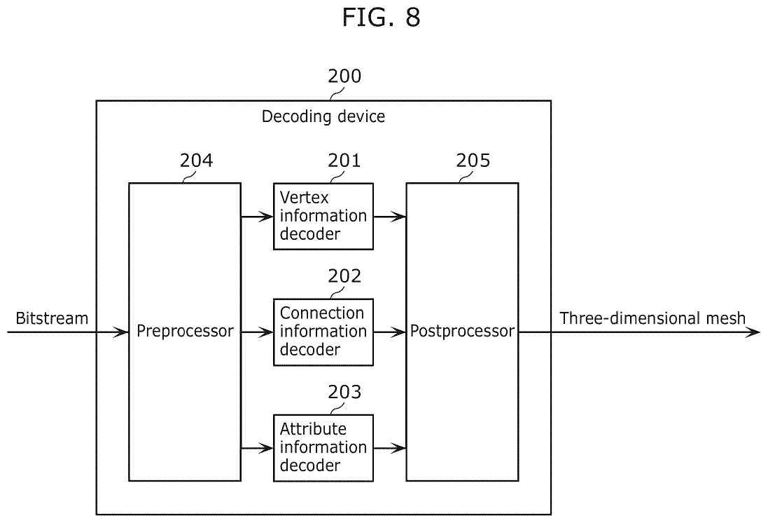

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### <Bitstream>

Vertex information, connection information, and attribute information are encoded and stored in a bitstream. A relationship between these pieces of information and the bitstream will be described below.

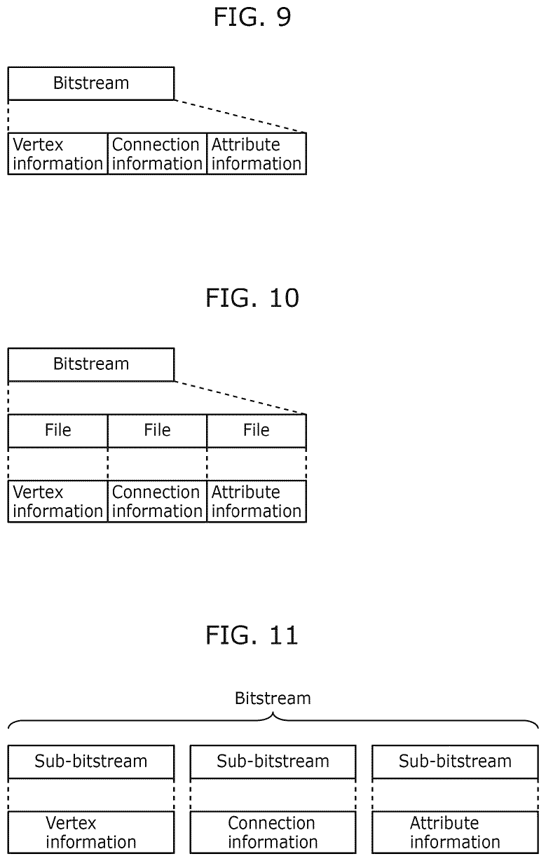

FIG. 9 is a conceptual diagram illustrating a configuration example of a bitstream according to the present embodiment. In this example, vertex information, connection information, and attribute information are integrated in the bitstream. For example, vertex information, connection information, and attribute information may be included in one file.

In addition, a plurality of portions of the pieces of information may be sequentially stored such as a first portion of vertex information, a first portion of connection information, a first portion of attribute information, a second portion of vertex information, a second portion of connection information, a second portion of attribute information, . . . . The plurality of portions may correspond to a plurality of temporally different portions, correspond to a plurality of spatially different portions, or correspond to a plurality of different faces.

Furthermore, an order of storage of vertex information, connection information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and vertex information, connection information, and attribute information are respectively stored in different files. While a file including vertex information, a file including connection information, and a file including attribute information are illustrated here, storage formats are not limited to this example. For example, two types of information among vertex information, connection information, and attribute information may be included in one file and the one remaining type of information may be included in another file.

Alternatively, the pieces of information can be stored by being divided into a larger number of files. For example, a plurality of portions of vertex information may be stored in a plurality of files, a plurality of portions of connection information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of vertex information, connection information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and vertex information, connection information, and attribute information are respectively stored in different sub-bitstreams.

While a sub-bitstream including vertex information, a sub-bitstream including connection information, and a sub-bitstream including attribute information are illustrated here, storage formats are not limited to this example.

For example, two types of information among vertex information, connection information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of vertex information and connection information.

In addition, each sub-bitstream may include a plurality of files. Furthermore, a plurality of portions of vertex information may be stored in a plurality of files, a plurality of portions of connection information may be stored in a plurality of files, and a plurality of portions of attribute information may be stored in a plurality of files.

### Specific Example

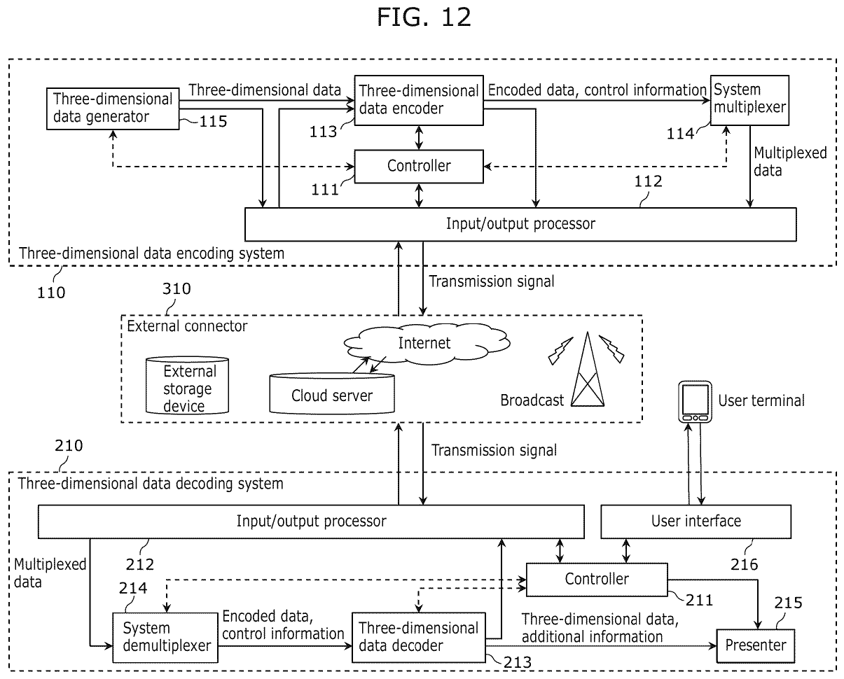

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

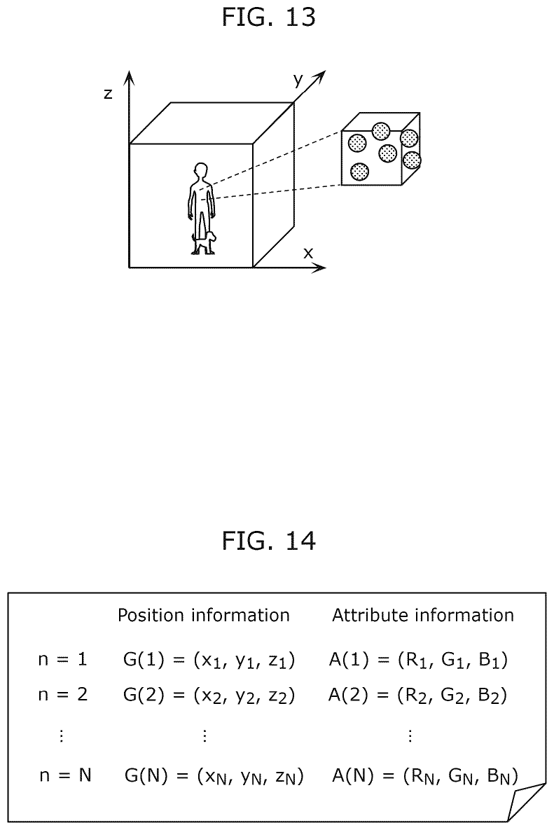

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

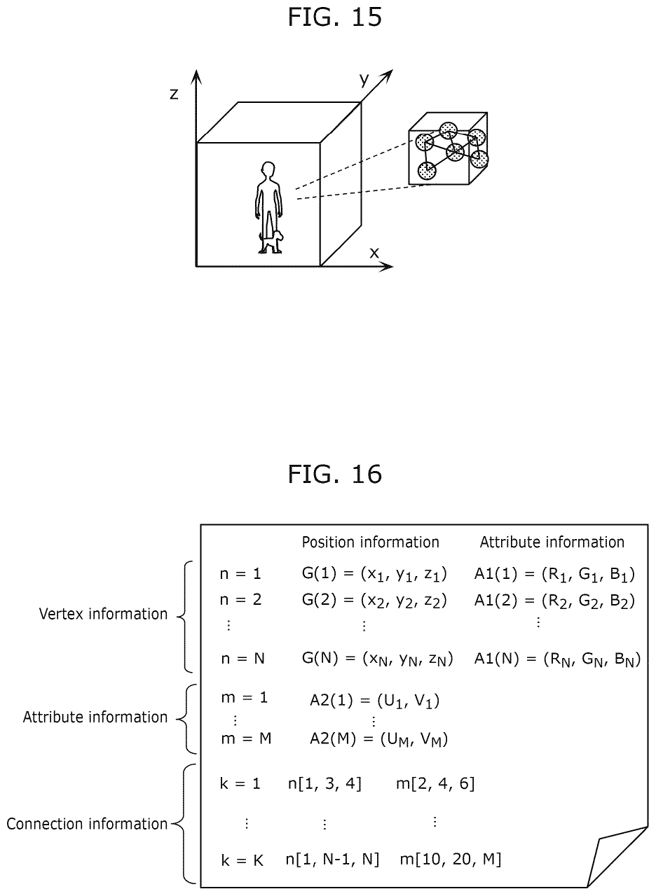

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n=1, n=3, and n=4. In addition, m [2, 4, 6] indicates that pieces of attribute information m=2, m=4, and m=6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

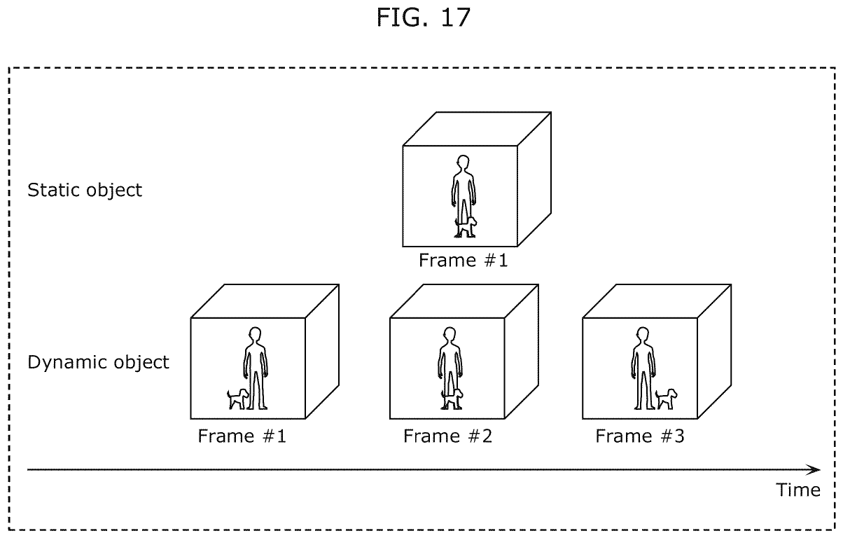

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

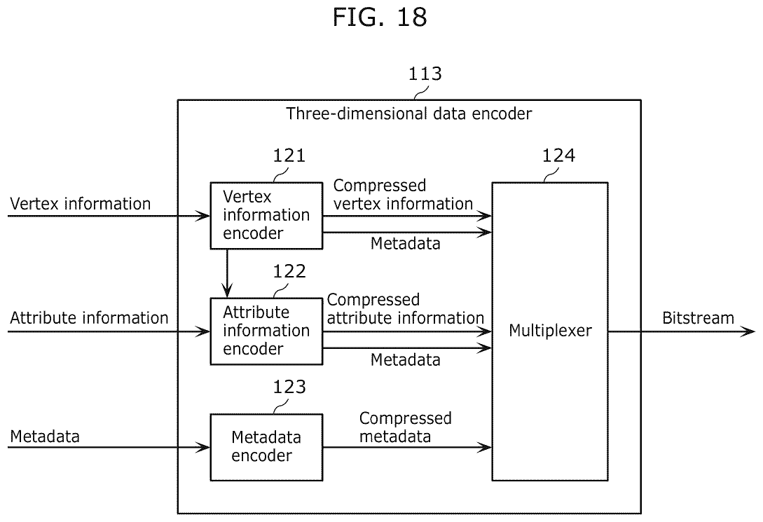

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

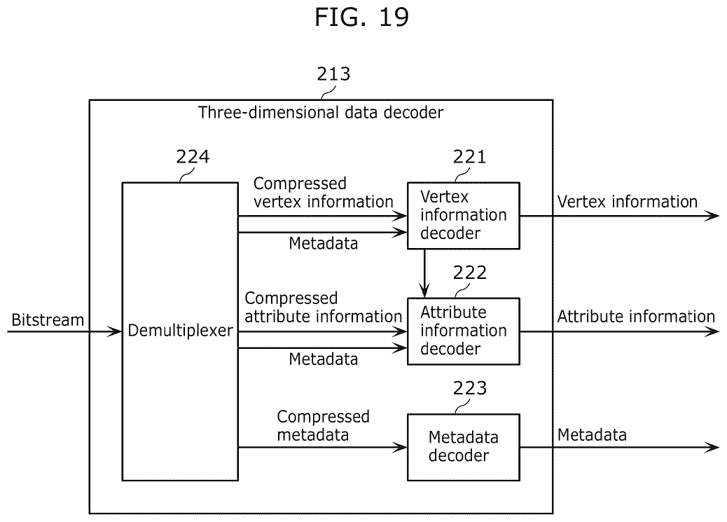

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

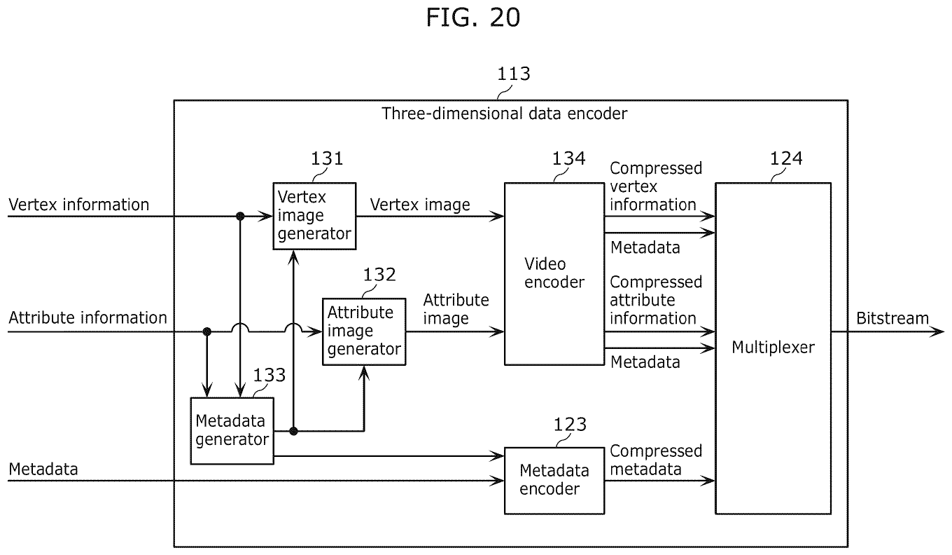

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

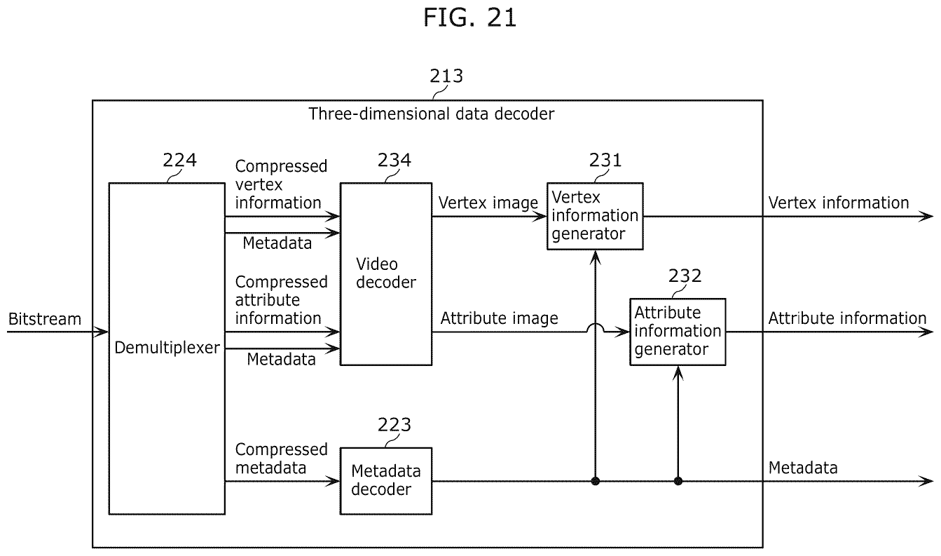

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

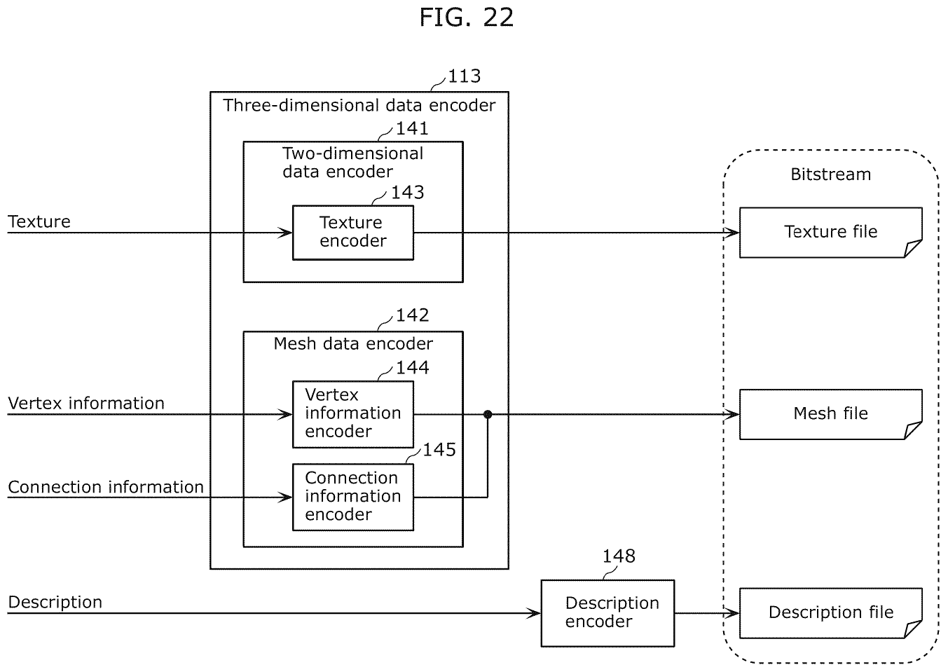

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

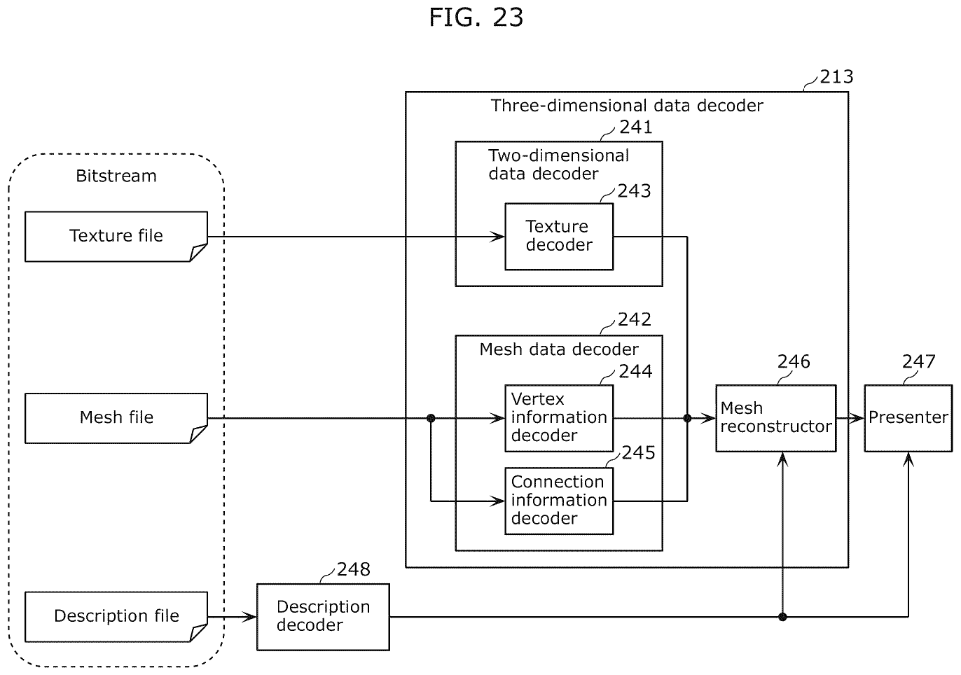

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation Example

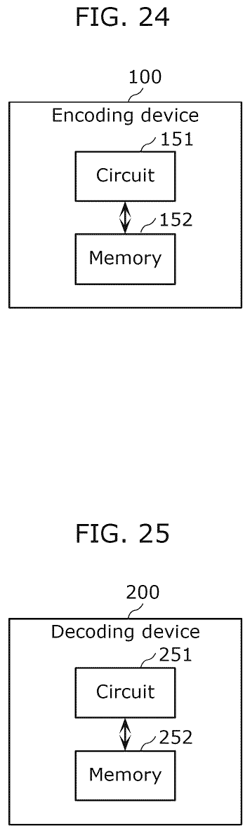

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

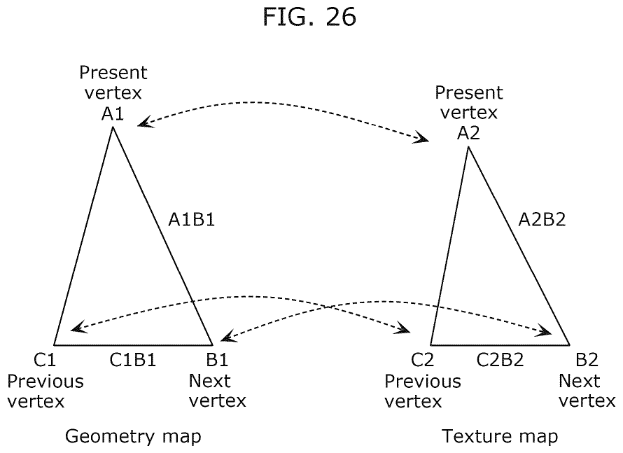

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### <Encoding and Decoding of Vertex Information>

Realistic 3D representations of objects are in increasing demand in a variety of industries including architectural design, engineering, healthcare, and video games. In most applications, three-dimensional models provide a more vivid experience than 2D images and 2D video. 3D polygon meshes are widely used to model structural shapes, leading to 3D digital animation of various objects.

Each polygon includes three-dimensional vertexes, edges connecting two vertexes, and faces made of two or more edges. As options, a polygon mesh may include an attribute such as a color, a normal, and a material.

Texture mapping is a technique often used to add visual appearance to a 3D model by projecting images onto its faces. The technique introduces the ability to substitute visual details without directly modifying the model and can improve performance when rendering is required. Information stored in a 2D texture image may be color, smoothness, transparency, and the like.

A relationship between a 3D mesh and a 2D texture image is established using a UV map (also called an attribute map or a texture map). The UV map is a version of a 3D mesh deformed and developed onto a 2D plane. Subsequently, the texture image is overlaid on the UV map and attribute values are projected from the image to the 3D model during rendering. Therefore, an encoding/decoding technique that enables a UV map to be efficiently stored and streamed is anticipated.

Different prediction schemes using different prediction modules based on a parameter display technique used to project a 3D mesh onto a 2D map, a relationship between texture coordinates and mesh geometry data, or the like can be used to encode texture coordinates of a UV map. In the case of isometric parameter display, the lengths of the edges of a triangle maintain approximately the same ratio in both 3D space and UV coordinates. Therefore, the texture coordinates on a UV map can be predicted using a ratio obtained from corresponding edges in 3D space.

FIG. 26 is a conceptual diagram illustrating examples of a geometry map, a texture map, and a relationship between the geometry map and the texture map. As illustrated in FIG. 26, texture coordinates A2, B2, and C2 are respectively associated with A1, B1, and C1 in the geometry map. A ratio between edge A1B1 and C1B1 in 3D space is calculated as A1B1/C1B1=R. Finally, the coordinates of A2 in UV space are predicted as A2B2=R×C2B2 and A2=B2+A2B2.

With respect to encoding texture coordinates, traditional approaches focus on encoding texture coordinates using error vectors calculated with the help of prediction schemes (parallelogram, ratio-based, and the like). Regardless of the complexity of such schemes, it is difficult to prove that a norm of the errors is within a specific boundary.

For example, an inferior triangle (obtuse triangle) tends to have a larger error vector than a superior triangle (equilateral triangle). It is needless to say that a smoothness of the shape and a variation in size of the faces will also impact a distribution of error norms. Therefore, efficiency of current methods is highly dependent on geometry and tessellation or, in other words, triangles of a mesh.

The proposed novel method uses, for example, two angles being internal angles of a face on a texture map to encode non-common texture coordinates of an adjacent triangle based on a reference triangle in order to reduce bits. The novelty of the proposed method is that only angles are used to encode the texture coordinates of the triangle mesh using a topological relationship between adjacent triangles.

For example, a 3D polygon mesh may substitute its visual appearance with a 2D image, and the relationship between the mesh and the image is established using a UV map. A 3D object is expanded and projected onto a 2D texture map of which coordinates in a horizontal direction and a vertical direction range from 0 to 1.

An object of the new solution presented herein is to compress coordinates of a UV map using an efficient method. An algorithm traverses over a map and encodes respective texture coordinates using two angles that represent geometric relationships between present coordinates and three previously-encoded coordinates.

A positive or negative sign value of an angle is used to indicate an orientation of the angle with respect to an edge where the angle is placed. A predetermined convention is adopted where a positive value signifies clockwise and a negative value signifies counterclockwise.

Since the texture map of a mesh is a two-dimensional plane, a set of texture coordinates can be encoded using two angles. In this case, the two angles express a spatial relationship between a face on which the set of texture coordinates is placed and an adjacent face.

In an aspect of the present disclosure, encoding device 100 traverses the entire mesh while encoding the texture coordinates using only angles. In another aspect of the present disclosure, a method of decoding a texture map using angles received from an encoded bitstream is provided. In this case, texture coordinates are derived using a geometric relationship between adjacent faces.

Therefore, encoding device 100 according to the present disclosure may enforce natural bounds on the possible values of angles used to encode a mesh texture map. Accordingly, a minimum compression rate can be guaranteed regardless of characteristics/quality of an input mesh.

In addition, since the values of the angles tend to follow a certain distribution, the compression rate can be further improved by taking advantage of such tendency. For example, the compression rate is expected to be improved by examining the distribution of angles and encoding a difference from a mean of the distribution.

Details of aspects of the present disclosure will be described below. It will be obvious to those skilled in the art that combinations of the plurality of described aspects may be implemented to further increase the benefits of the present disclosure.

The following disclosure also relates primarily to encoding and decoding vertex coordinates indicating a vertex on a texture map. However, the following disclosure may also be applied to encoding and decoding vertex coordinates indicating a vertex on a geometry map. In addition, in the present disclosure, vertex information is not limited to vertex information indicating a position of a vertex on a geometry map and includes vertex information indicating a position of a vertex on a texture map.

### <Encoding Processing of Vertex Information>

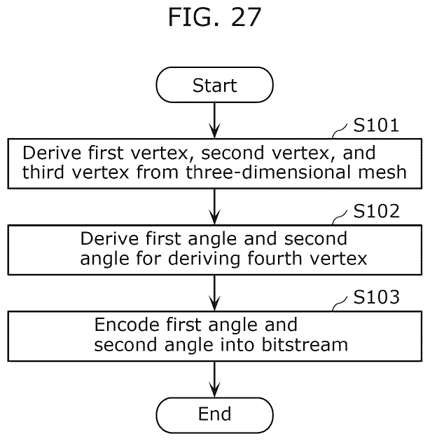

FIG. 27 is a flow chart illustrating an example of encoding processing according to the present embodiment. The encoding processing illustrated in FIG. 27 may constitute a part of encoding processing of a base mesh. In addition, a mesh may include a geometry map and a texture map.

First, a first vertex, a second vertex, and a third vertex are derived from a mesh (S101). In this case, the first vertex, the second vertex, and the third vertex form a first triangle on the mesh. For example, the first vertex, the second vertex, and the third vertex may form a face of the mesh.

Next, a first angle and a second angle for deriving a fourth vertex are derived (S102). The fourth vertex is a vertex of a second triangle. The second triangle is a triangle which shares a common edge with the first triangle and which is on a same plane as the first triangle. The fourth vertex forms the second triangle on the mesh using an edge shared with the first triangle. The first angle and the second angle may have values in a range from 0 degrees to 180 degrees.

In addition, the first angle and the second angle are encoded into a bitstream (S103). The first angle and the second angle may be encoded using entropy encoding.

In an example, the mesh is derived from a bitstream. In other words, in the example, the mesh constitutes a bitstream. In addition, in an example, the first vertex, the second vertex, the third vertex, and the fourth vertex represent texture coordinates (UV coordinates). In another example, the first vertex, the second vertex, the third vertex, and the fourth vertex may represent coordinates other than texture coordinates.

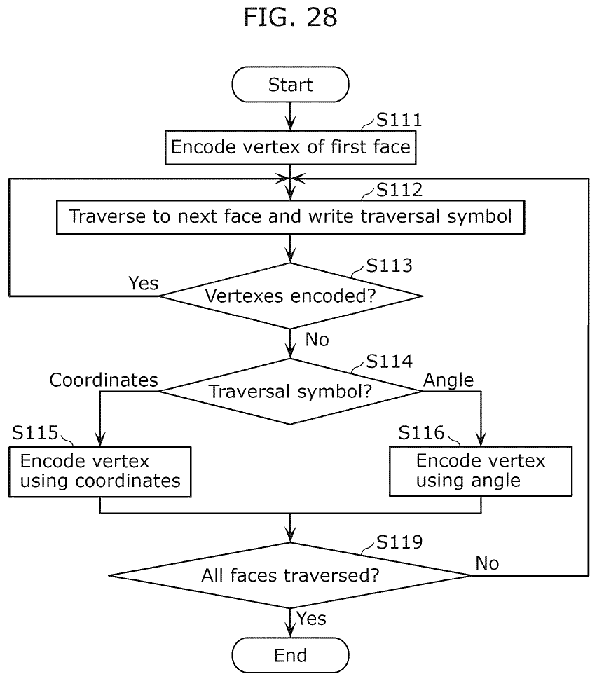

FIG. 28 is a flow chart illustrating a specific example of encoding processing according to the present aspect. First, a coordinate value of each vertex of a first face is encoded from a three-dimensional mesh (S111). The first face may be randomly selected.

Next, processing traverses to a next face (S112). In addition, a traversal symbol indicating a traversal instruction and a processing mode of a vertex is written to the bitstream.

At this point, when vertexes of the face have already been encoded (Yes in S113), encoding of the vertexes is skipped. In addition, when all faces have not been traversed, processing traverses to a next face. Note that when all faces have been traversed, processing may be ended.

On the other hand, when vertexes have not been encoded (No in S113), a processing mode of vertexes is designated according to the written traversal symbol.

A vertex is encoded using a coordinate value or an angle. For example, when the traversal symbol indicates coordinates (coordinates in S114), a vertex coordinate value (x, y, z) is directly encoded (S115). This method may be selected at start of encoding when none of the vertexes have been encoded. In addition, for example, when the traversal symbol indicates angles (angles in S114), a vertex is encoded using two angles (S116).

An additional residual error may be calculated or signaling may be separately performed after the signaling of angles. In an example where a floating-point value of an angle is to be fully expressed for the purpose of lossless encoding, a fractional portion of the floating-point value of the angle may be encoded as a residual error value after encoding an integer portion of the floating-point value of the angle. The traversal processing is continued until the entire three-dimensional mesh is traversed (S119).

A traversal symbol indicating any of skip, end, and execute may be encoded. Skip corresponds to a situation where a vertex has already been processed. End corresponds to a situation where all vertexes have already been processed. Execute corresponds to a situation where a vertex needs to be processed. In addition, when a traversal symbol indicating execute is encoded, a processing mode indicating either coordinates or angles may be encoded separately from the traversal symbol. A processing mode can also be expressed as a mode, an operating mode, a prediction mode, an encoding mode, or a decoding mode.

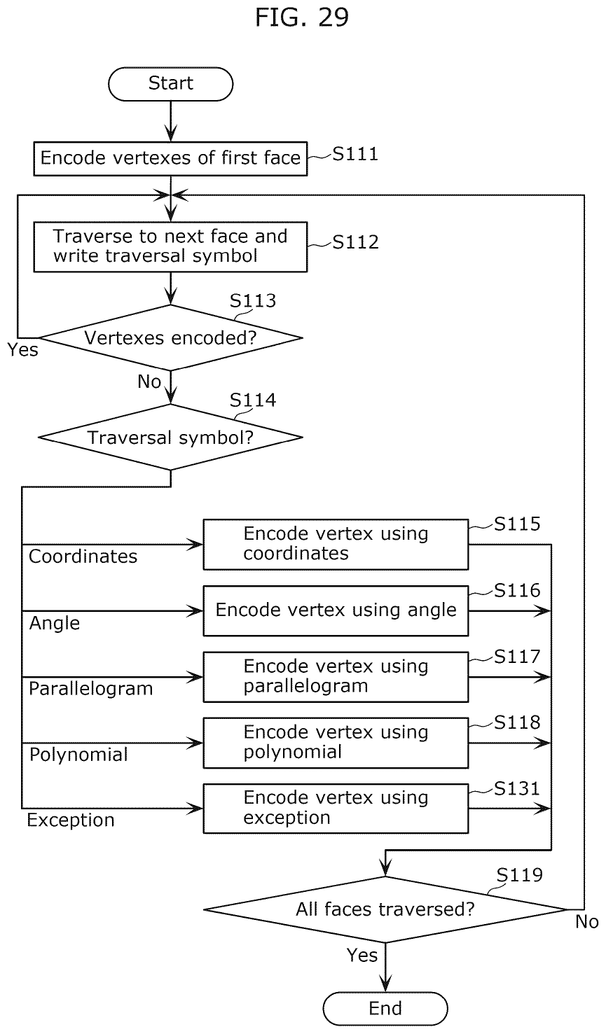

FIG. 29 is a flow chart illustrating another specific example of encoding processing according to the present aspect. In this example, the encoding processing according to the reference example is integrated with the encoding processing illustrated in FIG. 28. First, a coordinate value of each vertex of a first face is encoded from a three-dimensional mesh (S111).

Next, processing traverses to a next face (S112). In addition, a traversal symbol indicating a traversal instruction and a processing mode of a vertex are written to the bitstream.

At this point, when vertexes of the face have already been encoded (Yes in S113), encoding of the vertexes is skipped. In addition, when all faces have not been traversed, processing traverses to a next face. Note that when all faces have been traversed, processing may be ended.

On the other hand, when vertexes have not been encoded (No in S113), a processing mode of vertexes is designated according to the written traversal symbol.

A vertex is encoded using coordinates, angles, a parallelogram, or a polynomial. For example, when the traversal symbol indicates coordinates (coordinates in S114), a vertex coordinate value (x, y, z) is directly encoded (S115). This method may be selected at start of encoding when none of the vertexes have been encoded. In addition, for example, when the traversal symbol indicates angles (angles in S114), a vertex is encoded using two angles (S116).

Furthermore, for example, when the traversal symbol indicates a parallelogram (a parallelogram in S114), a vertex is encoded using a parallelogram (S117). In addition, for example, when the traversal symbol indicates a polynomial (a polynomial in S114), a vertex is encoded using a polynomial (S118). In addition, for example, when the traversal symbol indicates an exception (an exception in S114), a vertex is encoded using an exception (S131). Alternatively, when another processing mode is not available, a vertex may be encoded using an exception (such as another reference triangle).

An optimal processing mode may be determined based on a minimum cost among a plurality of costs which are calculated based on an encoding rate and a distortion with respect to a plurality of processing modes. The cost of an encoding rate and a distortion can be calculated based on the number of bits to be signaled and an error between an actual value and a predicted value. In addition, an optimal processing mode corresponding to a minimum error can be selected solely based on the error between an actual value and a predicted value.

The traversal processing is continued until the entire mesh is traversed (S119).

A traversal symbol indicating any of skip, end, and execute may be encoded. In addition, when a traversal symbol indicating execute is encoded, a processing mode indicating any of coordinates, angles, a parallelogram, and a polygon may be encoded separately from the traversal symbol. Note that when a processing mode has been determined in advance, the processing mode need not be encoded and processing steps need not be switched.

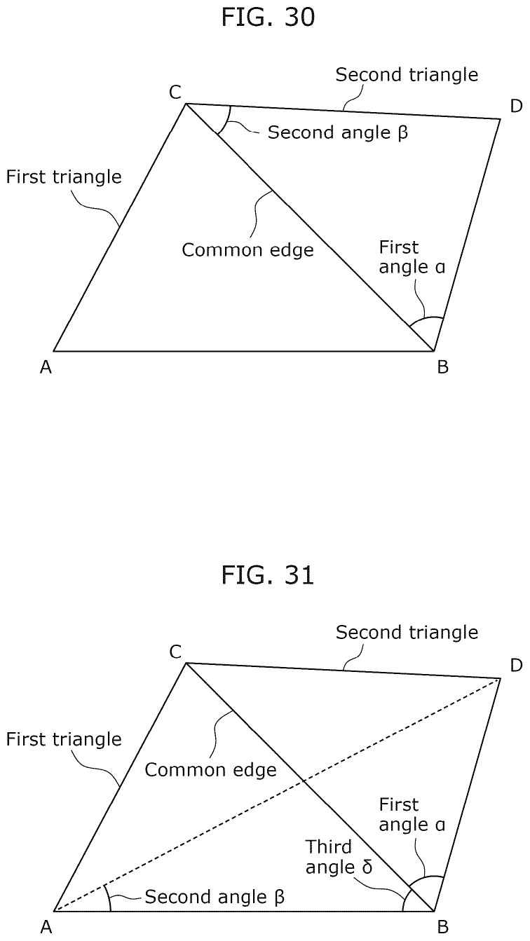

FIG. 30 is a conceptual diagram illustrating an example of two angles according to the present embodiment. A first angle α and a second angle β are in the second triangle in contact with a common edge. Using the vertex coordinates of the second triangle, the first angle α and the second angle β can be calculated as in Expression (1) below.

$$\begin{matrix}[ Math . 1 ] & \\ α = \frac{{\vert CB \vert}^{2} + {\vert BD \vert}^{2} - {\vert CD \vert}^{2}}{2 \times \vert CB \vert \times \vert BD \vert} & ( 1 )\end{matrix}$$

$$β = \frac{{\vert CB \vert}^{2} + {\vert CD \vert}^{2} - {\vert BD \vert}^{2}}{2 \times \vert CB \vert \times \vert CD \vert}$$

FIG. 31 is a conceptual diagram illustrating another example of two angles according to the present embodiment. This is an approach that involves a first angle α of the second triangle, a second angle β based on an imaginary line AD, and a calculated third angle δ. The first angle α and the second angle β can be calculated as in Expression (2) below. Note that the third angle δ need not be calculated by encoding device 100.

$$\begin{matrix}[ Math . 2 ] & \\ α = \frac{{\vert CB \vert}^{2} + {\vert BD \vert}^{2} - {\vert CD \vert}^{2}}{2 \times \vert CB \vert \times \vert BD \vert} & ( 2 )\end{matrix}$$

$$β = \frac{{\vert AB \vert}^{2} + {\vert AD \vert}^{2} - {\vert BD \vert}^{2}}{2 \times \vert AB \vert \times \vert AD \vert}$$

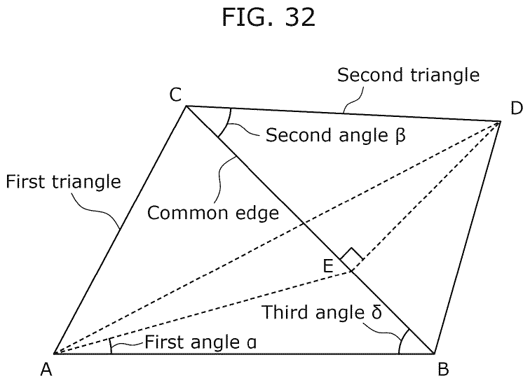

FIG. 32 is a conceptual diagram illustrating yet another example of two angles according to the present embodiment. A first angle α is an angle formed between AB and AE. A second angle β is an internal angle of the second triangle. E denotes an orthogonal projection of D with respect to the common edge. The first angle α and the second angle β can be calculated as in Expression (3) below. Note that the third angle δ need not be calculated by encoding device 100.

$$\begin{matrix}[ Math . 3 ] & \\ α = \frac{{\vert AB \vert}^{2} + {\vert AE \vert}^{2} - {\vert BE \vert}^{2}}{2 \times \vert AB \vert \times \vert AE \vert} & ( 3 )\end{matrix}$$

$$β = \frac{{\vert CB \vert}^{2} + {\vert CD \vert}^{2} - {\vert BD \vert}^{2}}{2 \times \vert CB \vert \times \vert CD \vert}$$

In an example, the first angle and the second angle can be encoded into a V3C-compliant bitstream.

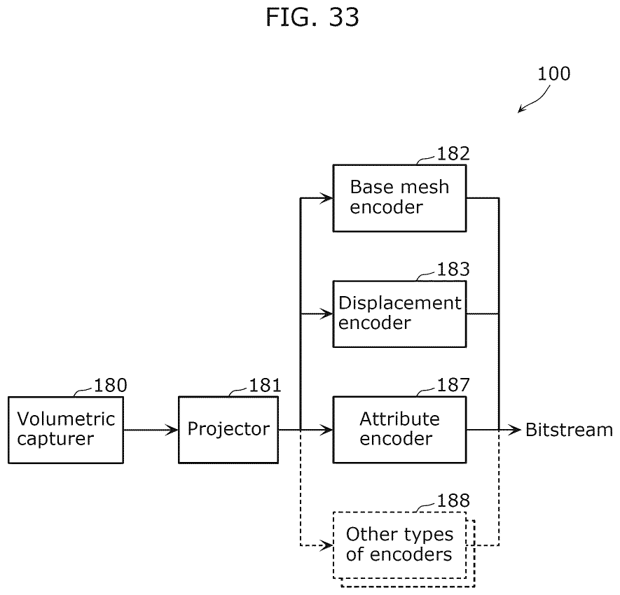

FIG. 33 is a block diagram illustrating a configuration example of V3C-compliant encoding device 100. In this example, encoding device 100 includes volumetric capturer 180, projector 181, base mesh encoder 182, displacement encoder 183, attribute encoder 187, and a plurality of other types of encoders 188. For example, texture coordinates can be encoded by base mesh encoder 182, displacement encoder 183, or both. In addition, a bitstream may be a V3C-compliant bitstream.

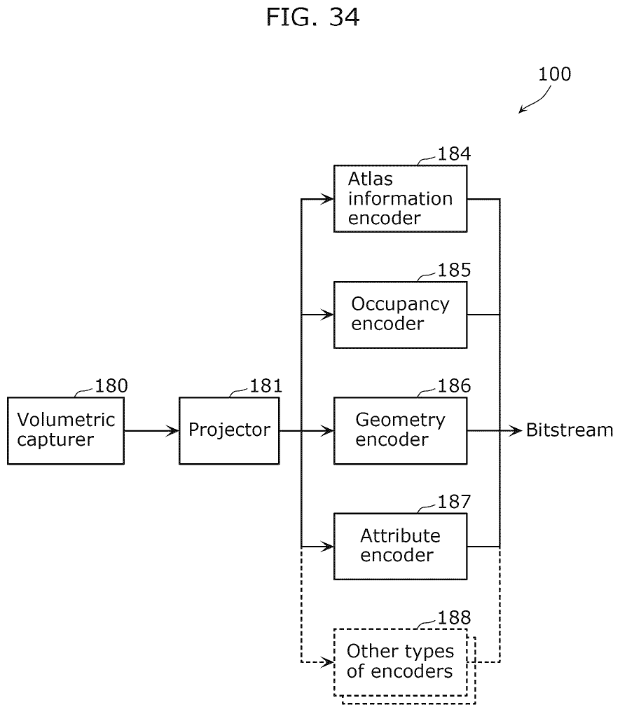

FIG. 34 is a block diagram illustrating another configuration example of a V3C-compliant encoding device. In this example, encoding device 100 includes volumetric capturer 180, projector 181, atlas information encoder 184, occupancy encoder 185, geometry encoder 186, attribute encoder 187, and a plurality of other types of encoders 188.

For example, texture coordinates are a part of attribute video data that can be encoded by attribute encoder 187. In addition, a bitstream may be a V3C-compliant bitstream.

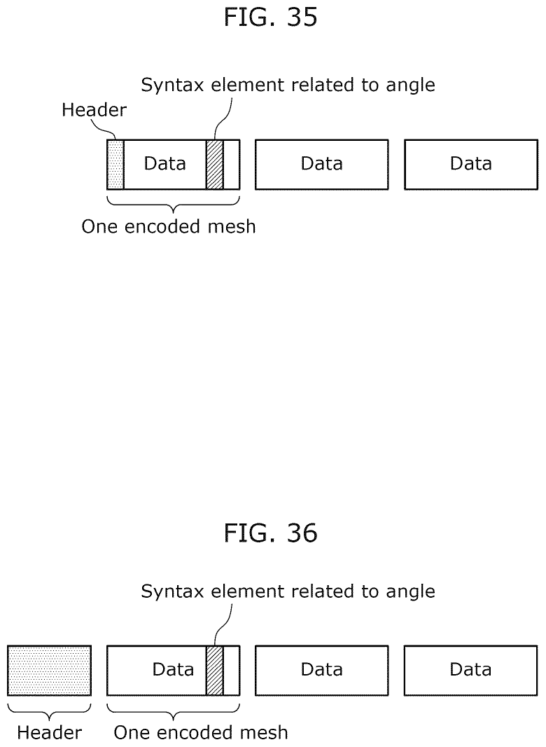

FIG. 35 is a conceptual diagram illustrating an example of a position of a syntax element of an angle in a bitstream. FIG. 35 illustrates examples of a layout of a bitstream and a possible position of a syntax element related to an angle. In this example, a header is provided with respect to a data portion for each encoded mesh. The syntax element related to an angle is included in the data portion for each encoded mesh.

FIG. 36 is a conceptual diagram illustrating another example of a position of a syntax element of an angle in a bitstream. FIG. 36 illustrates examples of a layout of a bitstream and a possible position of a syntax element related to an angle. In this example, a common header is provided with respect to a plurality of data portions of a plurality of encoded meshes. The syntax element related to an angle is included in the data portion for each encoded mesh.

In other words, the syntax element related to an angle is included in the data portion of the bitstream in both the example illustrated in FIG. 35 and the example illustrated in FIG. 36.

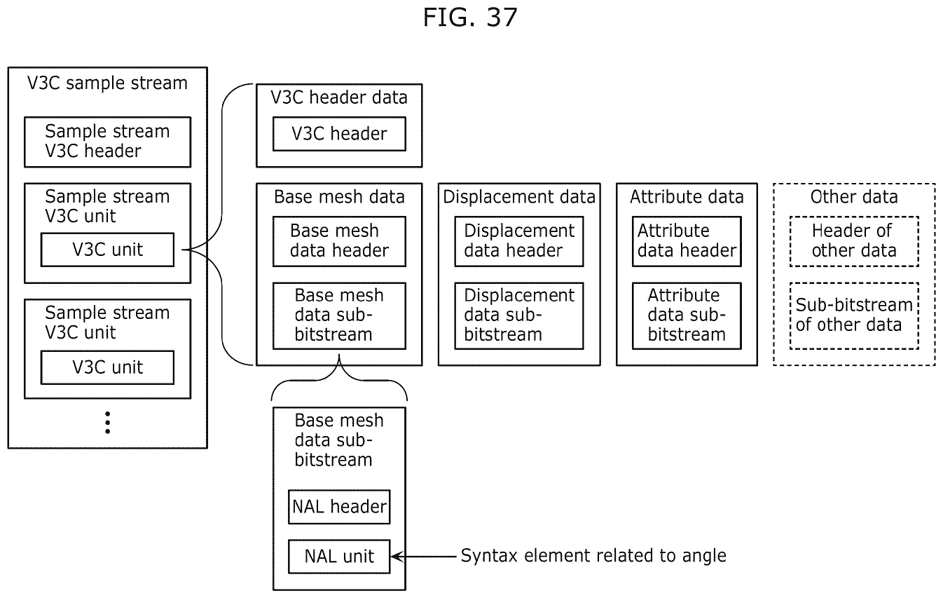

FIG. 37 is a conceptual diagram illustrating an example of a position of a syntax element of an angle in a V3C sample stream. FIG. 37 illustrates examples of a bitstream layout of a V3C sample stream and a possible position of a syntax element related to an angle. The bitstream of the V3C sample stream in the example illustrated in FIG. 37 corresponds to the bitstream in the example illustrated in FIG. 33.

In the example illustrated in FIG. 37, the syntax element related to an angle is encoded to an NAL unit of a base mesh data sub-bitstream.

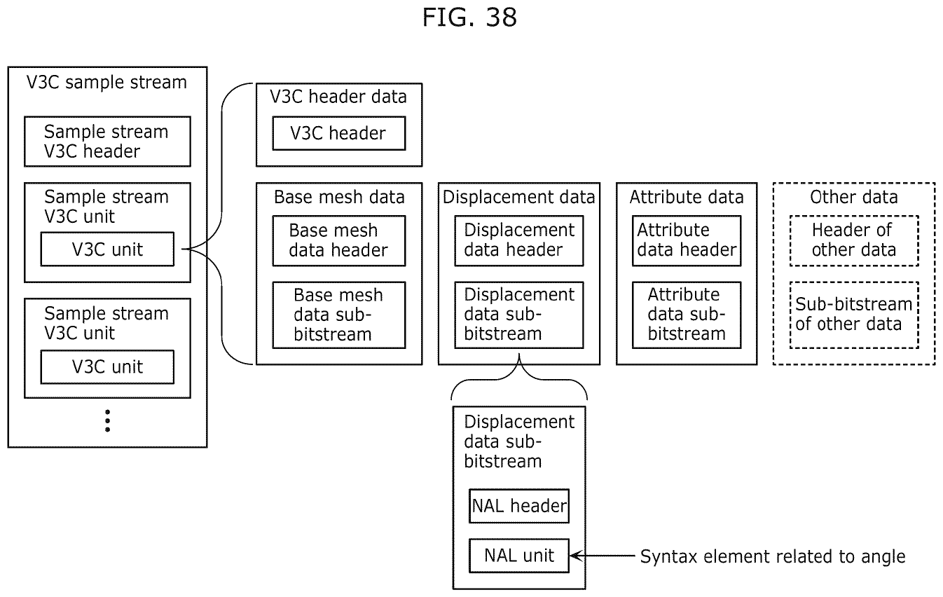

FIG. 38 is a conceptual diagram illustrating another example of a position of a syntax element of an angle in a V3C sample stream. FIG. 38 illustrates other examples of a bitstream layout of a V3C sample stream and a possible position of a syntax element related to an angle. The bitstream of the V3C sample stream in the example illustrated in FIG. 38 corresponds to the bitstream in the example illustrated in FIG. 33.

In the example illustrated in FIG. 38, the syntax element related to an angle is encoded to an NAL unit of a displacement data sub-bitstream.

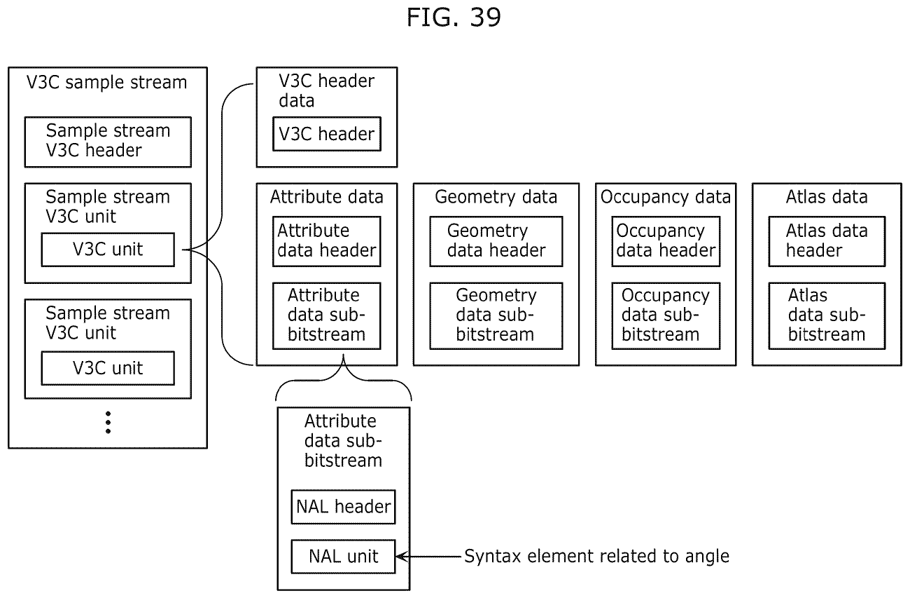

FIG. 39 is a conceptual diagram illustrating yet another example of a position of a syntax element of an angle in a V3C sample stream. FIG. 39 illustrates yet other examples of a bitstream layout of a V3C sample stream and a possible position of a syntax element related to an angle. The bitstream of the V3C sample stream in the example illustrated in FIG. 39 corresponds to the bitstream in the example illustrated in FIG. 34.

In the example illustrated in FIG. 39, the syntax element related to an angle is encoded to an NAL unit of an attribute data sub-bitstream.

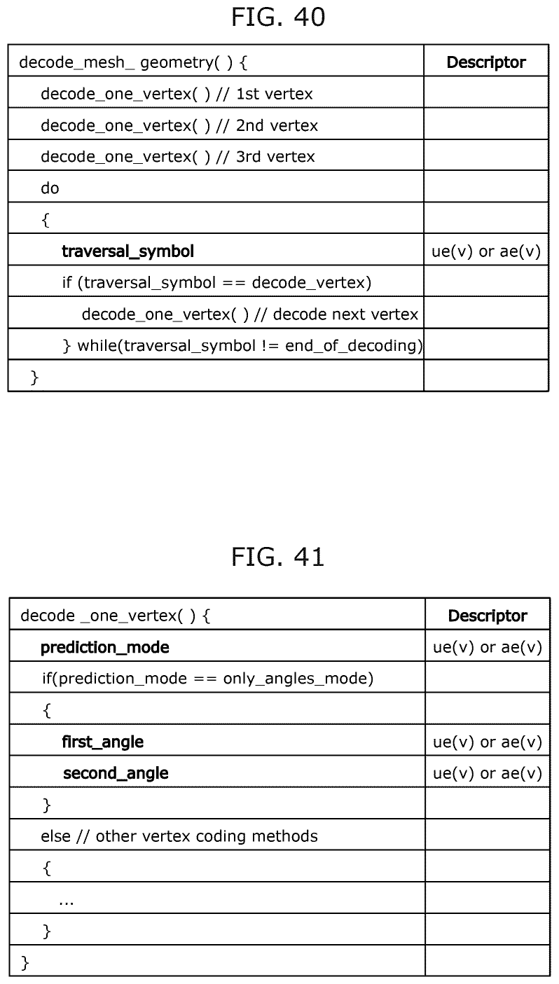

FIG. 40 is a syntax diagram illustrating a syntax structure example of vertex information with respect to a plurality of vertexes in a case where a prediction mode is individually derived. In the example, after three vertexes are encoded, a traversal symbol is encoded with respect to each of the other vertexes. In addition, whether or not the vertex is to be encoded is controlled according to the traversal symbol.

FIG. 41 is a syntax diagram illustrating a syntax structure example of vertex information with respect to one vertex in a case where a prediction mode is individually derived. In the example, when the prediction mode (prediction_mode) is equivalent to the angle mode (only_angles_mode), derived angles with respect to the first angle and the second angle are directly encoded. Furthermore, in this example, the prediction mode of the vertex is to be signaled before encoding the two angles.

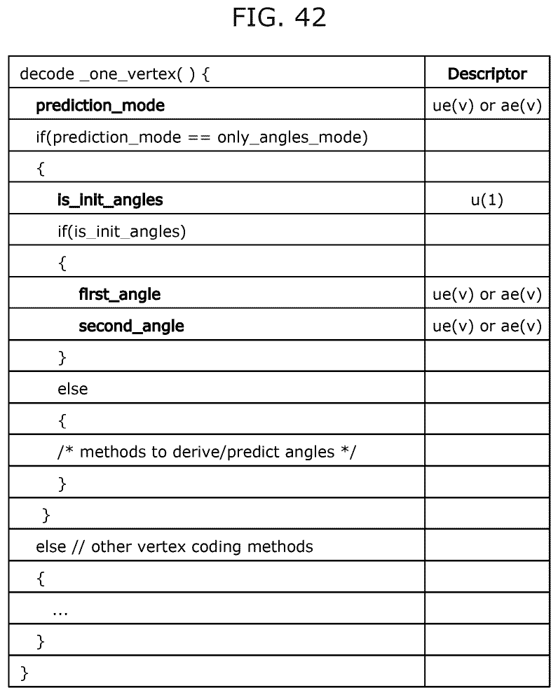

FIG. 42 is a syntax diagram illustrating another syntax structure example of vertex information with respect to one vertex in a case where a prediction mode is individually derived. In the example, according to is_init_angles, a method of deriving or predicting the two angles without directly encoding the two angles is used. The example of a method of deriving or predicting two angles is a method of using a history list of previously encoded angles. Furthermore, in this example, the prediction mode of the vertex is to be signaled before encoding the two angles.

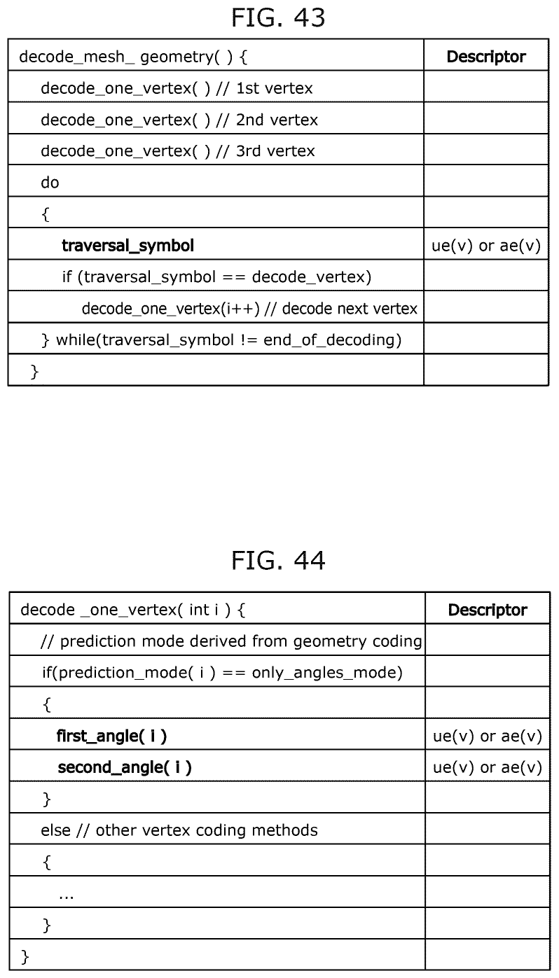

FIG. 43 is a syntax diagram illustrating a syntax structure example of vertex information with respect to a plurality of vertexes in a case where a prediction mode is derived from a corresponding vertex on a geometry map. In the example, after three vertexes are encoded, a traversal symbol is encoded with respect to each of the other vertexes. In addition, whether or not the vertex is to be encoded is controlled according to the traversal symbol.

FIG. 44 is a syntax diagram illustrating a syntax structure example of vertex information with respect to one vertex in a case where a prediction mode is derived from a corresponding vertex on a geometry map. In the example, when the prediction mode (prediction_mode) is equivalent to the angle mode (only_angles_mode), derived angles with respect to the first angle and the second angle are directly encoded. In addition, in this example, a prediction mode of a vertex is derived from an associated vertex on the geometry map.

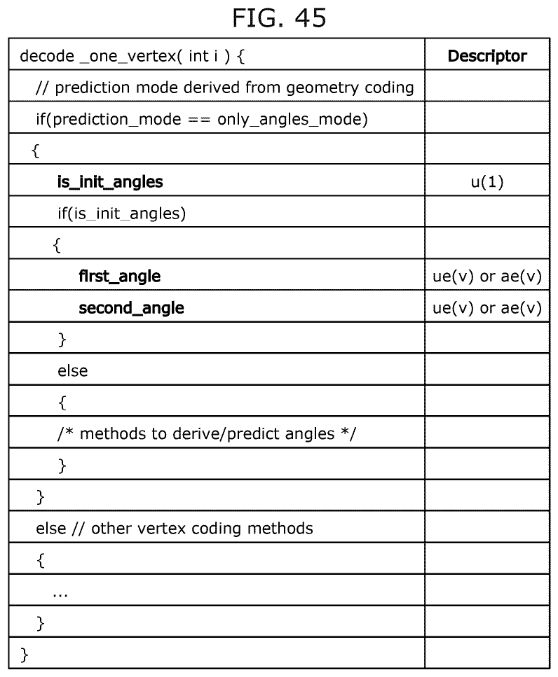

FIG. 45 is a syntax diagram illustrating another syntax structure example of vertex information with respect to one vertex in a case where a prediction mode is derived from a corresponding vertex on a geometry map. In the example, according to is_init_angles, a method of deriving or predicting the two angles without directly encoding the two angles is used. The example of a method of deriving or predicting two angles is a method of using a history list of previously encoded angles. In addition, in this example, a prediction mode of a vertex is derived from a corresponding vertex on the geometry map.

In another example, a flag may be present in the header to indicate whether the prediction mode of a vertex is derived from a corresponding vertex on the geometry map or the prediction mode is to be signaled before encoding the two angles.

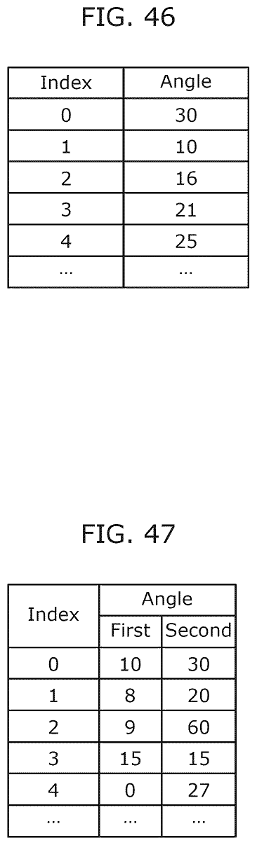

FIG. 46 is a table diagram illustrating an example of a table used in prediction of an angle. In the example, a previously encoded angle and an index are associated with each other and stored in a table. Angles to be stored in the table may be calculated by averaging two previously encoded angles. Angles stored in the table may be listed according to first-in first-out, an occurrence rate of values, or a combination of first-in first-out and an occurrence rate of values. Indexes may be fixed values.

In addition, one of a plurality of angles in the table is used as a predicted angle. When encoding (writing) a syntax element, only an index value corresponding to the predicted angle and delta being a difference between an actual angle and the predicted angle are encoded into a bitstream.

FIG. 47 is a table diagram illustrating another example of a table used in prediction of an angle. In the example, a first angle and a second angle which have previously been encoded are associated with an index and stored in a table. Angles stored in the table may be listed according to first-in first-out, an occurrence rate of values, or a combination of first-in first-out and an occurrence rate of values. Indexes may be fixed values.

In addition, one combination among a plurality of combinations in the table is used as a combination of predicted angles. When encoding (writing) a syntax element, only an index value corresponding to a combination of the predicted angle and delta being a difference between an actual angle and the predicted angle are encoded into a bitstream.

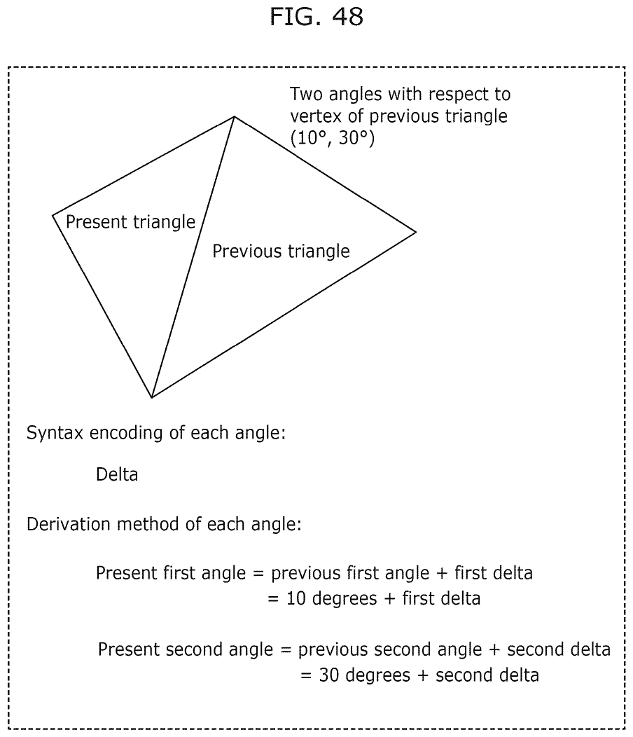

FIG. 48 is a conceptual diagram illustrating an example of prediction using an angle with respect to a vertex of a previous triangle. In this example, two angles with respect to a vertex of a present triangle are derived or predicted using two angles with respect to a vertex of a previous triangle. The previous triangle is a triangle that is traversed before the present triangle. The previous triangle may be a triangle which immediately precedes the present triangle or a triangle which is adjacent to the present triangle.

Specifically, in this example, first delta and second delta indicating two angles with respect to vertexes of the present triangle are determined and encoded using two angles (10 degrees and 30 degrees) with respect to vertexes of the previous triangle. For example, when the first angle with respect to a vertex of the present triangle is 11 degrees, first delta is determined and encoded by 11 degrees−10 degrees=1 degree. In addition, when the second angle with respect to a vertex of the present triangle is 32 degrees, second delta is determined and encoded by 32 degrees−30 degrees=2 degrees.

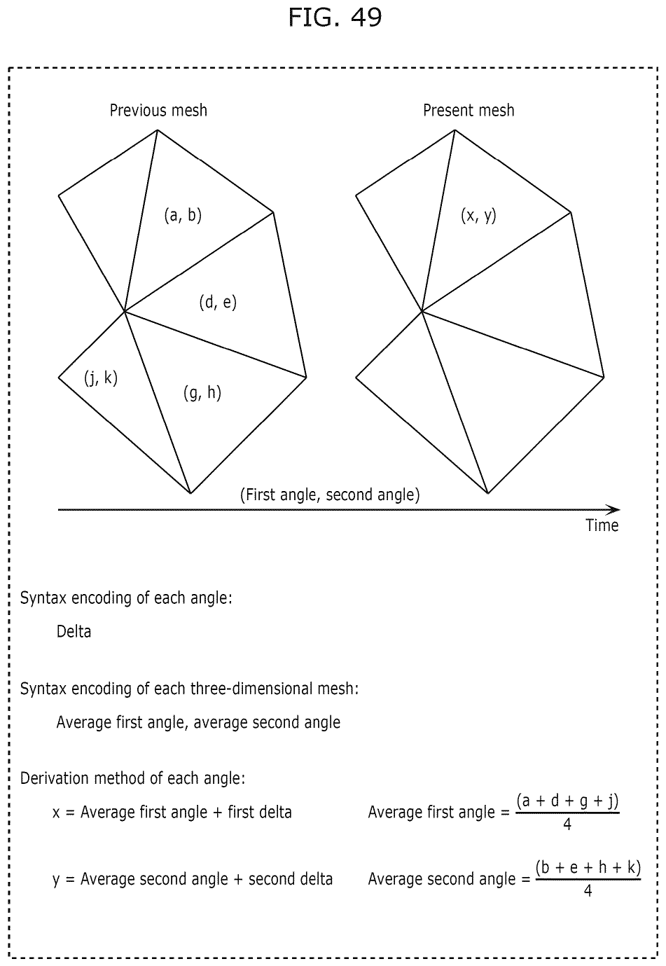

FIG. 49 is a conceptual diagram illustrating an example of prediction using an angle with respect to a vertex of a previous mesh. In this example, two angles are derived or predicted using a plurality of angles with respect to a plurality of vertexes of the previous mesh. In this case, a mesh can be expressed as a map.

For example, the previous mesh is a mesh which spatially differs from the present mesh and is a mesh having been processed before the present mesh. Alternatively, for example, the previous mesh is a mesh which temporally differs from the present mesh and is a mesh having been processed before the present mesh.

An average first angle and an average second angle with respect to a plurality of vertexes of the previous mesh may be encoded in the present mesh. In addition, first delta indicating the first angle may be determined and encoded by first delta=first angle x−average first angle. Furthermore, second delta indicating the second angle may be determined and encoded by second delta=second angle y−average second angle. For example, this method can be used in a dynamic mesh in which a plurality of adjacent frames have spatial redundancy.

In another example, a first angle and a second angle in texture encoding can be predicted by reference to a corresponding first angle and a corresponding second angle in geometry encoding. Differences between respective angle values may be encoded. In addition, a value of is_init_angles in texture encoding may be the same as a corresponding value in geometry encoding.

A code amount can be reduced by deriving the value in texture encoding by reference to the value in geometry encoding instead of signaling the value in texture encoding. Alternatively, a code amount can be reduced by encoding the difference in texture encoding by reference to the value in geometry encoding.

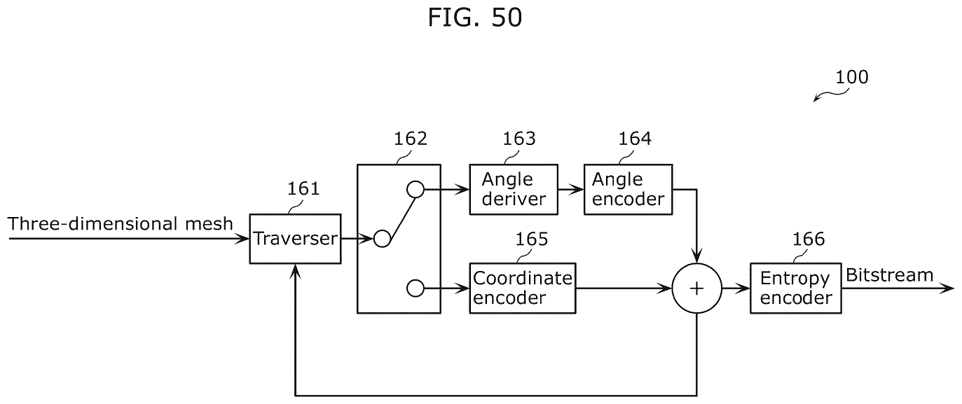

FIG. 50 is a block diagram illustrating a configuration example of encoding device 100 according to the present embodiment. A plurality of components of encoding device 100 illustrated in FIG. 50 may be included in base mesh encoder 182 or the like such as that illustrated in FIG. 33.

Encoding device 100 encodes a mesh into a bitstream. In this example, specifically, encoding device 100 encodes coordinates indicating a position of a vertex of the mesh. Encoding object coordinates may be texture coordinates (UV coordinates) indicating a position of a vertex on a texture map or geometry coordinates indicating a position of a vertex on a geometry map.

As illustrated in FIG. 50, encoding device 100 may include traverser 161, switch 162, angle deriver 163, angle encoder 164, coordinate encoder 165, and entropy encoder 166.

Traverser 161 acquires a mesh. Traverser 161 may acquire a texture map as the mesh. A texture map includes texture coordinates (UV coordinates) indicating a position of each vertex of a texture. In addition, traverser 161 determines a vertex that is an object of encoding in the mesh and outputs the vertex to any of angle deriver 163 and coordinate encoder 165 via switch 162.

In an example, traverser 161 selects coordinate encoder 165 with respect to first three vertexes of the mesh and selects angle deriver 163 with respect to other vertexes.

For example, coordinate encoder 165 captures three vertexes which form a first triangle and encodes the three vertexes. Delta encoding may be used to encode the three vertexes. Specifically, a coordinate value of a first vertex may be directly encoded and a difference between the coordinate value of the first vertex and a coordinate value of a second vertex and a difference between the coordinate value of the first vertex and a coordinate value of a third vertex may be encoded.

Angle deriver 163 captures a fourth vertex that forms a second triangle on a same plane as a first triangle using a shared edge with the first triangle, derives two angles to be used for identifying the fourth vertex D, and outputs the two derived angles to angle encoder 164. As described above, FIGS. 30, 31, and 32 illustrate different examples related to two angles.

Angle encoder 164 encodes the two angles. An additional residual error may be calculated and separately signaled after the signaling of angles. In an example where a floating-point value of an angle is to be fully expressed for the purpose of lossless encoding, angle encoder 164 may encode a fractional portion of the floating-point value of the angle as a residual error value after encoding an integer portion of the floating-point value of the angle. Alternatively, angle encoder 164 may encode, as a displacement vector, an error between the coordinates represented by integer angles and the original coordinates.

Encoding information obtained by coordinate encoder 165 and encoding information obtained by angle encoder 164 are sent to entropy encoder 166 and are also fed back to traverser 161. Entropy encoder 166 compresses the encoding information and outputs a bitstream. Traverser 161 uses the encoding information to determine a next traversal.

An encoding system to which entropy encoding conforms may be any of Huffman coding, arithmetic coding, range coding, ANS (asymmetric numeral systems), and CABAC (context-adaptive binary arithmetic coding).

Encoding device 100 encodes a mesh according to the configuration and processing described above. Accordingly, a code amount of the mesh may be suppressed.

### <Decoding Processing of Vertex Information>

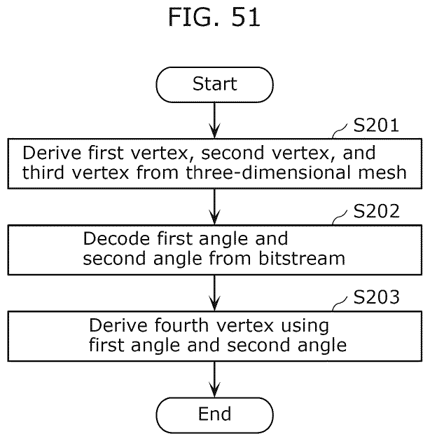

FIG. 51 is a flow chart illustrating an example of decoding processing according to the present embodiment. The decoding processing illustrated in FIG. 51 may constitute a part of decoding processing of a base mesh. In addition, a mesh may include a geometry map and a texture map.

First, a first vertex, a second vertex, and a third vertex are derived from a mesh (S201). In this case, the first vertex, the second vertex, and the third vertex form a first triangle on the mesh. For example, the first vertex, the second vertex, and the third vertex may form a face of the mesh.

Next, a first angle and a second angle are decoded from a bitstream (S202). The first angle and the second angle may be decoded in accordance with entropy encoding. In decoding, entropy encoding may be expressed as entropy decoding. The first angle and the second angle may have values in a range from 0 degrees to 180 degrees.

In addition, a fourth vertex is derived using the decoded first angle and the decoded second angle (S203). In this case, the fourth vertex is a vertex of a second triangle. The second triangle is a triangle which shares a common edge with the first triangle and which is on a same plane as the first triangle. The fourth vertex forms the second triangle on the mesh using an edge shared with the first triangle.

In an example, the mesh is derived from a bitstream. In other words, in the example, the mesh constitutes a bitstream. In addition, in an example, the first vertex, the second vertex, the third vertex, and the fourth vertex represent texture coordinates (UV coordinates). In another example, the first vertex, the second vertex, the third vertex, and the fourth vertex may represent coordinates other than texture coordinates.

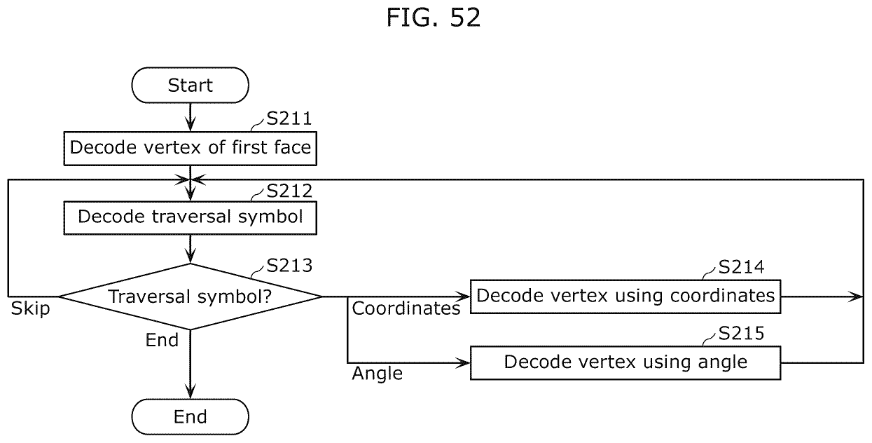

FIG. 52 is a flow chart illustrating a specific example of decoding processing according to the present embodiment. Decoding processing starts by decoding a coordinate value of each vertex of an initial face having been initially encoded (S211). Subsequently, a traversal symbol of the present face is decoded (S212). In addition, a determination is made as to which of coordinates, angles, skip, and end the traversal symbol indicates (S213).

For example, when the traversal symbol indicates coordinates (coordinates in S213), a vertex coordinate value is directly decoded (S214). In addition, for example, when the traversal symbol indicates angles (angles in S213), a vertex is decoded using two angles (S215). Furthermore, when the traversal symbol indicates skip (skip in S213), processing with respect to the next face is repeated. Moreover, when the traversal symbol indicates end (end in S213), processing is ended.

A traversal symbol indicating any of skip, end, and execute may be decoded. Skip corresponds to a situation where a vertex has already been processed. End corresponds to a situation where all vertexes have already been processed. Execute corresponds to a situation where a vertex needs to be processed. In addition, when a traversal symbol indicating execute is decoded, a processing mode indicating either coordinates or angles may be decoded separately from the traversal symbol. A processing mode can also be expressed as a mode, an operating mode, a prediction mode, an encoding mode, or a decoding mode.

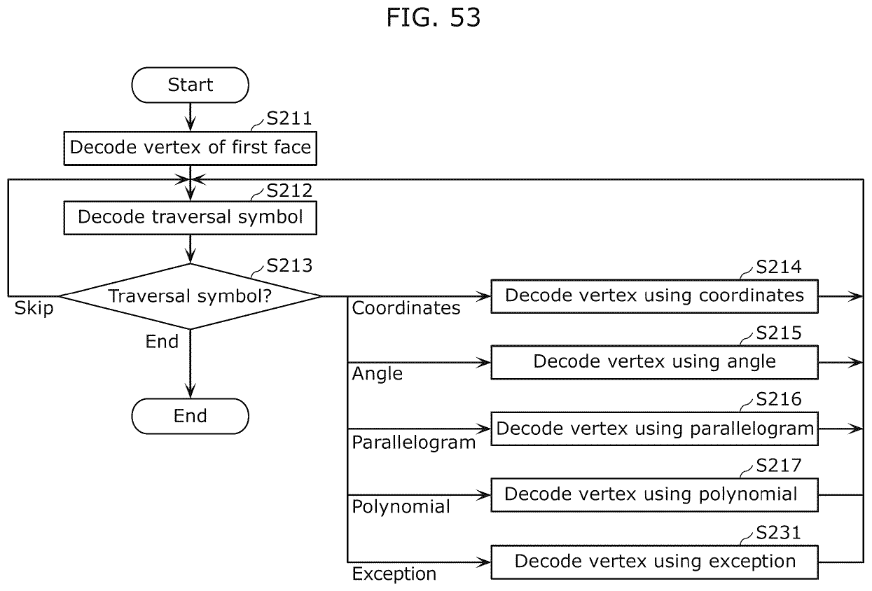

FIG. 53 is a flow chart illustrating another specific example of decoding processing according to the present aspect. In this example, a plurality of other decoding processings are integrated with the decoding processing illustrated in FIG. 52. Decoding processing starts by decoding a coordinate value of each vertex of an initial face having been initially encoded (S211). Subsequently, a traversal symbol of the present face is decoded (S212). In addition, a determination is made as to which of coordinates, angles, a parallelogram, a polynomial, an exception, skip, and end the traversal symbol indicates (S213).

For example, when the traversal symbol indicates coordinates (coordinates in S213), a vertex coordinate value is directly decoded (S214). In addition, for example, when the traversal symbol indicates angles (angles in S213), a vertex is decoded using two angles (S215). Furthermore, when the traversal symbol indicates a parallelogram (a parallelogram in S213), a vertex is decoded using a parallelogram (S216). In addition, for example, when the traversal symbol indicates a polynomial (a polynomial in S213), a next vertex is decoded using a polynomial (S217).

In addition, when the traversal symbol indicates an exception (an exception in S213), a vertex is decoded using an exception (S231). Alternatively, when another processing mode is not available, a vertex may be decoded using an exception (such as another reference triangle).

Furthermore, when the traversal symbol indicates skip (skip in S213), processing with respect to the next face is repeated. Moreover, when the traversal symbol indicates end (end in S213), processing is ended.

A traversal symbol indicating any of skip, end, and execute may be decoded. In addition, when a traversal symbol indicating execute has been decoded, a processing mode indicating any of coordinates, angles, a parallelogram, and a polygon may be decoded separately from the traversal symbol. Note that when a processing mode has been determined in advance, the processing mode need not be decoded and processing steps need not be switched.

In an example, the first angle and the second angle can be decoded from a V3C-compliant bitstream.

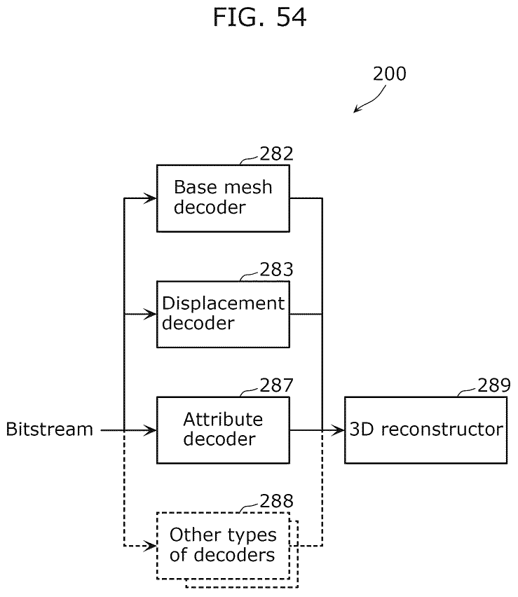

FIG. 54 is a block diagram illustrating a configuration example of V3C-compliant decoding device 200. In this example, decoding device 200 includes base mesh decoder 282, displacement decoder 283, attribute decoder 287, a plurality of other types of decoders 288, and 3D reconstructor 289. For example, texture coordinates can be decoded by base mesh decoder 282, displacement decoder 283, or both. In addition, a bitstream may be a V3C-compliant bitstream.

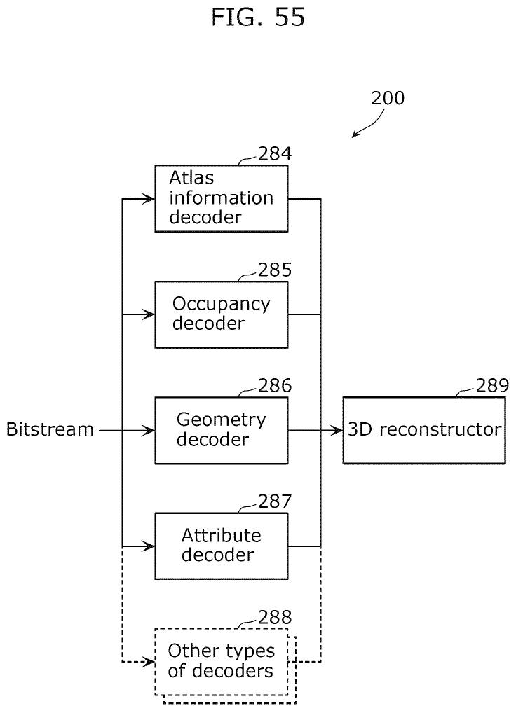

FIG. 55 is a block diagram illustrating another configuration example of V3C-compliant decoding device 200. In this example, decoding device 200 includes atlas information decoder 284, occupancy decoder 285, geometry decoder 286, attribute decoder 287, a plurality of other types of decoders 288, and 3D reconstructor 289.

For example, texture coordinates are a part of attribute video data that is decoded by attribute decoder 287. In addition, a bitstream may be a V3C-compliant bitstream.

FIG. 35 is a conceptual diagram illustrating an example of a position of a syntax element of an angle in a bitstream. FIG. 35 illustrates examples of a layout of a bitstream and a possible position of a syntax element related to an angle. In this example, a header is provided with respect to a data portion for each encoded mesh. The syntax element related to an angle is included in the data portion for each encoded mesh.

FIG. 36 is a conceptual diagram illustrating another example of a position of a syntax element of an angle in a bitstream. FIG. 36 illustrates examples of a layout of a bitstream and a possible position of a syntax element related to an angle. In this example, a common header is provided with respect to a plurality of data portions of a plurality of encoded meshes. The syntax element related to an angle is included in the data portion for each encoded mesh.

In other words, the syntax element related to an angle is included in the data portion of the bitstream in both the example illustrated in FIG. 35 and the example illustrated in FIG. 36.

FIG. 37 is a conceptual diagram illustrating an example of a position of a syntax element of an angle in a V3C sample stream. FIG. 37 illustrates examples of a bitstream layout of a V3C sample stream and a possible position of a syntax element related to an angle. The bitstream of the V3C sample stream in the example illustrated in FIG. 37 corresponds to the bitstream in the example illustrated in FIG. 54.

In the example illustrated in FIG. 37, the syntax element related to an angle is decoded from an NAL unit of a base mesh data sub-bitstream.

FIG. 38 is a conceptual diagram illustrating another example of a position of a syntax element of an angle in a V3C sample stream. FIG. 38 illustrates other examples of a bitstream layout of a V3C sample stream and a possible position of a syntax element related to an angle. The bitstream of the V3C sample stream in the example illustrated in FIG. 38 corresponds to the bitstream in the example illustrated in FIG. 54.

In the example illustrated in FIG. 38, the syntax element related to an angle is decoded from an NAL unit of a displacement data sub-bitstream.

FIG. 39 is a conceptual diagram illustrating yet another example of a position of a syntax element of an angle in a V3C sample stream. FIG. 39 illustrates yet other examples of a bitstream layout of a V3C sample stream and a possible position of a syntax element related to an angle. The bitstream of the V3C sample stream in the example illustrated in FIG. 39 corresponds to the bitstream in the example illustrated in FIG. 55.

In the example illustrated in FIG. 39, the syntax element related to an angle is decoded from an NAL unit of an attribute data sub-bitstream.

FIG. 40 is a syntax diagram illustrating a syntax structure example of vertex information with respect to a plurality of vertexes in a case where a prediction mode is individually derived. In the example, after three vertexes are decoded, a traversal symbol is decoded with respect to each of the other vertexes. In addition, whether or not vertexes are to be decoded is controlled according to the traversal symbol.

FIG. 41 is a syntax diagram illustrating a syntax structure example of vertex information with respect to one vertex in a case where a prediction mode is individually derived. In the example, when the prediction mode (prediction_mode) is equivalent to the angle mode (only_angles_mode), derived angles with respect to the first angle and the second angle are directly decoded. Furthermore, in this example, the prediction mode of the vertex is to be signaled before decoding the two angles.

FIG. 42 is a syntax diagram illustrating another syntax structure example of vertex information with respect to one vertex in a case where a prediction mode is individually derived. In the example, according to is_init_angles, a method of deriving or predicting the two angles without directly decoding the two angles is used. The example of a method of deriving or predicting two angles is a method of using a history list of previously decoded angles. Furthermore, in this example, the prediction mode of the vertex is to be signaled before decoding the two angles.

FIG. 43 is a syntax diagram illustrating a syntax structure example of vertex information with respect to a plurality of vertexes in a case where a prediction mode is derived from a corresponding vertex on a geometry map. In the example, after three vertexes are decoded, a traversal symbol is decoded with respect to each of the other vertexes. In addition, whether or not vertexes are to be decoded is controlled according to the traversal symbol.

FIG. 44 is a syntax diagram illustrating a syntax structure example of vertex information with respect to one vertex in a case where a prediction mode is derived from a corresponding vertex on a geometry map. In the example, when the prediction mode (prediction_mode) is equivalent to the angle mode (only_angles_mode), derived angles with respect to the first angle and the second angle are directly decoded. In addition, in this example, a prediction mode of a vertex is derived from a corresponding vertex on the geometry map.

FIG. 45 is a syntax diagram illustrating another syntax structure example of vertex information with respect to one vertex in a case where a prediction mode is derived from a corresponding vertex on a geometry map. In the example, according to is_init_angles, a method of deriving or predicting the two angles without directly decoding the two angles is used. The example of a method of deriving or predicting two angles is a method of using a history list of previously decoded angles. In addition, in this example, a prediction mode of a vertex is derived from a corresponding vertex on the geometry map.

In another example, a flag may be present in the header to indicate whether the prediction mode of a vertex is derived from a corresponding vertex on the geometry map or the prediction mode is to be signaled before decoding the two angles.

FIG. 46 is a table diagram illustrating an example of a table used in prediction of an angle. In the example, a previously decoded angle and an index are associated with each other and stored in a table. The angle to be stored in the table may be calculated by averaging two previously decoded angles. Angles stored in the table may be listed in a first-in, first-out manner, listed according to an occurrence rate of values, or listed according to a combination thereof. Indexes may be fixed values.

In addition, one of a plurality of angles in the table is used as a predicted angle. When decoding (reading) a syntax element, only an index value corresponding to the predicted angle and delta being a difference between an actual angle and the predicted angle are decoded from a bitstream.

FIG. 47 is a table diagram illustrating another example of a table used in prediction of an angle. In the example, a first angle and a second angle which have previously been decoded are associated with an index and stored in a table. Angles stored in the table may be listed in a first-in, first-out manner, listed according to an occurrence rate of values, or listed according to a combination thereof. Indexes may be fixed values.

In addition, one combination among a plurality of combinations in the table is used as a combination of predicted angles. When decoding (reading) a syntax element, only an index value corresponding to the combination of predicted angles and delta being a difference between actual angles and the predicted angles are decoded from a bitstream.

FIG. 48 is a conceptual diagram illustrating an example of prediction using an angle with respect to a vertex of a previous triangle. In this example, two angles with respect to a vertex of a present triangle are derived or predicted using two angles with respect to a vertex of a previous triangle. The previous triangle is a triangle that is traversed before the present triangle. The previous triangle may be a triangle which immediately precedes the present triangle or a triangle which is adjacent to the present triangle.

Specifically, in this example, two deltas are decoded and two angles with respect to vertexes of the present triangle are derived using the two deltas and two angles (10 degrees and 30 degrees) with respect to vertexes of the previous triangle. For example, when 1 degree is decoded as the first delta, the first angle is derived by 10 degrees+1 degree=11 degrees. In addition, for example, when 2 degrees are decoded as the second delta, the second angle is derived by 30 degrees+2 degrees=32 degrees.

FIG. 49 is a conceptual diagram illustrating an example of prediction using an angle with respect to a vertex of a previous mesh. In this example, two angles are derived or predicted using a plurality of angles with respect to a plurality of vertexes of the previous mesh. In this case, a mesh can be expressed as a map.

For example, the previous mesh is a mesh which spatially differs from the present mesh and is a mesh having been processed before the present mesh. Alternatively, for example, the previous mesh is a mesh which temporally differs from the present mesh and is a mesh having been processed before the present mesh.

An average first angle and an average second angle with respect to a plurality of vertexes of the previous mesh may be decoded in the present mesh. In addition, first delta indicating the first angle is decoded and the first angle is derived by first angle x=average first angle+first delta. Furthermore, second delta indicating the second angle is decoded and the second angle is derived by second angle y=average second angle+second delta. For example, this method can be used in a dynamic mesh in which a plurality of adjacent frames have spatial redundancy.

In another example of decoding a first angle and a second angle, the first angle and the second angle can be predicted by reference to a first angle and a second angle derived from a corresponding triangle in geometry decoding. In order to obtain final values of the first angle and the second angle, the decoded first angle and the decoded second angle are added to respective angle values derived by geometry decoding. A value of is_init_angles may be the same as the value present in geometry decoding. A code amount can be reduced by deriving the value by reference to the syntax of geometry instead of signaling is_init_angle for texture decoding.

FIG. 30 is a conceptual diagram illustrating an example of two angles according to the present embodiment. A first angle α and a second angle β are in the second triangle in contact with a common edge. In the example, two internal angles of the second triangle are decoded from a bitstream. When the two angles (first angle α and second angle β) of the second triangle are given, Expression (4) below is obtained by applying the sine theorem to triangle CBD. In addition, coordinates of point D is obtained from Expression (4).

$$\begin{matrix}[ Math . 4 ] & \\ \vert BD \vert = \frac{\vert CB \vert \times sin β}{sin α + β} & ( 4 )\end{matrix}$$

$$\vert CD \vert = \frac{\vert CB \vert \times sin α}{sin α + β}$$

FIG. 31 is a conceptual diagram illustrating another example of two angles according to the present embodiment. This is an approach that involves a first angle α of the second triangle, a second angle β based on an imaginary line AD, and a calculated third angle δ. After vertexes A, B, and C are decoded from a bitstream, the third angle δ can be derived as in Expression (5) below.

$$\begin{matrix}[ Math . 5 ] & \\ δ = \frac{{\vert AB \vert}^{2} + {\vert BC \vert}^{2} - {\vert AC \vert}^{2}}{2 \times \vert AB \vert \times \vert BC \vert} & ( 5 )\end{matrix}$$

Next, applying the sine theorem to triangle ABD results in a length of BD as in Expression (6) below.

$$\begin{matrix}[ Math . 6 ] & \\ \vert BD \vert = \frac{\vert AB \vert \times sin β}{sin ( α + β + δ )} & ( 6 )\end{matrix}$$

Therefore, coordinates of point D are obtained based on an orientation and a magnitude of BD with respect to BC and the fact that point D is coplanar with A, B, and C.

FIG. 32 is a conceptual diagram illustrating yet another example of two angles according to the present embodiment. The third angle & can be calculated by Expression (5) above. Expression (7) is obtained due to the decoded first angle of triangle AEB and the sine theorem.

$$\begin{matrix}[ Math . 7 ] & \\ \vert EB \vert = \frac{\vert AB \vert \times sin ( α )}{sin ( α + δ )} & ( 7 )\end{matrix}$$

Coordinates of point E that is an orthogonal projection of point D to edge BC is obtained from Expression (7). Next, Expression (8) is obtained by the right triangle rule in triangle CDE.

$$\begin{matrix}[ Math . 8 ] & \\ \vert CD \vert = \frac{\vert CE \vert}{cos β} & ( 8 )\end{matrix}$$

Therefore, coordinates of point D are obtained based on an orientation and a magnitude of CD with respect to BC and the fact that point D is coplanar with A, B, and C.

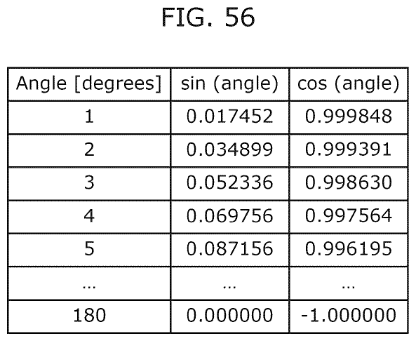

FIG. 56 is a table diagram illustrating an example of a look-up table of a sine function and a cosine function. The look-up table illustrated in FIG. 56 may be used in the calculation of the sine function and the cosine function described above.

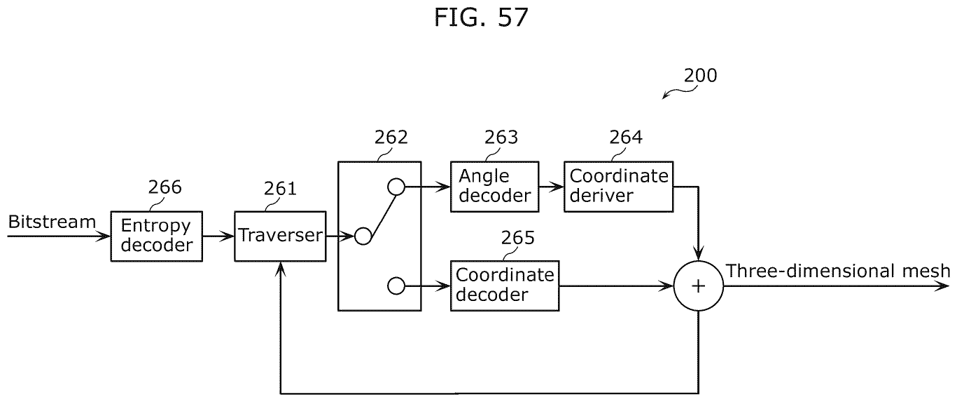

FIG. 57 is a block diagram illustrating a configuration example of decoding device 200 according to the present embodiment. A plurality of components of decoding device 200 illustrated in FIG. 57 may be included in base mesh decoder 282 or the like such as that illustrated in FIG. 54.

Decoding device 200 decodes a mesh from a bitstream. In this example, specifically, decoding device 200 decodes coordinates indicating a position of a vertex of the mesh. Decoding object coordinates may be texture coordinates (UV coordinates) indicating a position of a vertex on a texture map or geometry coordinates indicating a position of a vertex on a geometry map.

As illustrated in FIG. 57, decoding device 200 may include traverser 261, switch 262, angle decoder 263, coordinate deriver 264, coordinate decoder 265, and entropy decoder 266.

Entropy decoder 266 acquires a bitstream. Entropy decoder 266 acquires decompression information by decompressing the bitstream and outputs the decompression information. An example of an encoding system to which entropy decoding conforms may be any of Huffman coding, arithmetic coding, range coding, ANS (asymmetric numeral systems), and CABAC (context-adaptive binary arithmetic coding).

Decompression information is input to traverser 261. Traverser 261 interprets the decompression information and outputs the decompression information to any of angle decoder 263 and coordinate decoder 265 via switch 262.

Coordinate decoder 265 decodes three vertexes which form a first triangle from decompression information. As an example of decoding three vertexes, a coordinate value of a first vertex and two difference values are decoded from decompression information. Next, a coordinate value of a second vertex and a coordinate value of a third vertex are derived by adding the two difference values to the coordinate value of the first vertex.

Angle decoder 263 decodes two angles from the decompression information and outputs the two angles to coordinate deriver 264.

Using the two angles, coordinate deriver 264 derives a vertex of the second triangle which shares a common edge with the first triangle and which is on a same plane as the first triangle. Specifically, coordinate deriver 264 derives a vertex of the second triangle from the two angles using the derivation method described above with reference to FIGS. 30, 31, and 32.

Vertex information indicating the vertex obtained by coordinate deriver 264 or coordinate decoder 265 is output as vertex information of the mesh. In addition, the vertex information is fed back to traverser 261 to be used to determine a next traversal.

Decoding device 200 decodes a mesh according to the configuration and processing described above. Accordingly, a code amount of the three-dimensional mesh may be suppressed.

### <Supplement to Encoding and Decoding of Vertex Information>

The encoding processing and decoding processing according to the present embodiment can be applied to, for example, encoding and decoding of position information of a point in a point cloud compression system such as V-PCC (Video-based Point Cloud Compression) or G-PCC (Geometry-based Point Cloud Compression).

Encoding device 100 encodes information used for identifying vertex D of triangle BCD from reference triangle ABC or the three vertexes A, B, and C of reference triangle ABC. Decoding device 200 decodes information used for identifying vertex D of triangle BCD from reference triangle ABC or the three vertexes A, B, and C of reference triangle ABC. For example, the information used for identifying vertex D is angle information indicating two angles.

Note that information used for identifying vertex D may include, as the angle information described above or in place of the angle information described above, “information related to a position and a shape of a polygon (triangle BCD)”. In addition, a position of a vertex (vertex D) of the polygon (triangle BCD) may be identified based on the “information related to a position and a shape of a polygon (triangle BCD)”.

In addition, any of the pieces of information may be indicated using at least one angle. Accordingly, there is a possibility that a code amount may be reduced and flexibility and accuracy of prediction may improve.

In addition, for example, the following example may be added to the configuration and the processing described above or at least a part of the configuration and the processing described above may be replaced with the following examples.

For example, “information related to a position and a shape of a polygon” may be information that identifies a position and a shape of triangle BCD. When information related to a position and a shape of reference triangle ABC or position information of the three vertexes A, B, and C of the reference triangle ABC is identified, the information identifying the position and the shape of triangle BCD may indicate information indicating edge BC, an angle formed between edge BC and edge CD, and an angle formed between edge BC and edge BD. In this case, the information indicating edge BC corresponds to information indicating that triangle BCD which shares edge BC with triangle ABC is to be used.

Information indicating vertex A may be encoded instead of information indicating edge BC. The information indicating vertex A corresponds to information indicating that vertex D is on an opposite side to vertex A with edge BC between vertex D and vertex A. Accordingly, the position and the shape of third triangle BCD or, in other words, position information of vertex D can be derived from only two angles and a code amount can be reduced as compared to a case where the coordinate value of vertex D is encoded.

As each of the two angles described above, the angle itself may be encoded or an index that identifies one angle among a plurality of angles defined in advance may be encoded. A plurality of combinations of the two angles may be defined in advance. In addition, an index that identifies one combination among the plurality of combinations may be encoded.

Information indicating one angle and a length of one edge may be encoded instead of the two angles described above. For example, an angle formed between edge BC and edge BD and the length of edge BD may be encoded. In addition, information indicating one angle and a length of one perpendicular may be encoded instead of the two angles described above. For example, an angle formed between edge BC and edge BD and the length of a perpendicular drawn from vertex D to edge BC may be encoded.

In addition, information indicating lengths of two edges may be encoded instead of the two angles described above. For example, the lengths of edge BD and edge CD may be encoded.

In addition, by selecting a processing method such as an encoding method or a decoding method for each processing object vertex, processing methods may be switched among a plurality of processing methods. In this case, information indicating the processing method used to encode the processing object vertex may be encoded. Alternatively, processing methods may be switched among a plurality of processing methods by selecting a processing method in units of meshes and information indicating a processing method may be encoded in units of meshes.

Accordingly, a processing method in accordance with a property of the mesh may become selectable and an improvement in subjective image quality and a reduction in a code amount may be possible.

### Representative Example

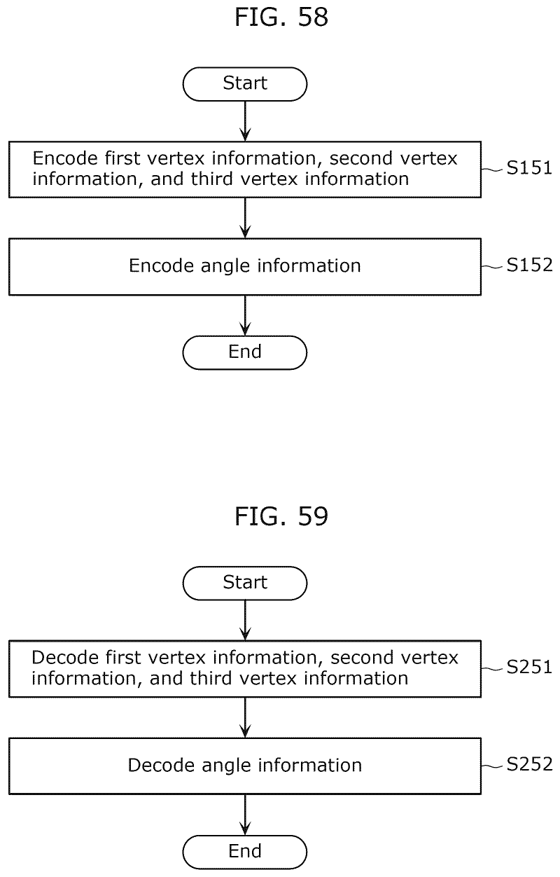

FIG. 58 is a flow chart illustrating an example of basic encoding processing according to the present embodiment. For example, circuit 151 of encoding device 100 illustrated in FIG. 24 performs the encoding processing illustrated in FIG. 58 in an operation.

Specifically, circuit 151 encodes first vertex information indicating a position of a first vertex of a first triangle, second vertex information indicating a position of a second vertex of the first triangle, and third vertex information indicating a position of a third vertex of the first triangle into a bitstream (S151). In addition, circuit 151 encodes angle information indicating one or more angles used for identifying a position of a fourth vertex of a second triangle by reference to the first triangle into the bitstream (S152). In this case, the second triangle is a triangle which shares a common edge with the first triangle and which is on a same plane as the first triangle.

Accordingly, angle information may possibly be encoded as information used for identifying the position of the fourth vertex. For example, it can be assumed that the value of each angle indicated by the angle information is included in a certain range such as from 0 degrees to 180 degrees. Therefore, an increase in a code amount may possibly be suppressed.

For example, each of the first vertex, the second vertex, the third vertex, and the fourth vertex may be a vertex on a geometry map of a three-dimensional space. Accordingly, angle information used for identifying a position of the fourth vertex of the second triangle by reference to the first triangle that includes the first vertex, the second vertex, and the third vertex on the geometry map of the three-dimensional space may possibly be encoded. Therefore, an increase in a code amount may possibly be suppressed with respect to geometry information of the three-dimensional space.

For example, each of the first vertex, the second vertex, the third vertex, and the fourth vertex may be a vertex on a texture map of a two-dimensional plane. Accordingly, angle information used for identifying a position of the fourth vertex of the second triangle by reference to the first triangle that includes the first vertex, the second vertex, and the third vertex on the texture map of the two-dimensional plane may possibly be encoded. Therefore, an increase in a code amount may possibly be suppressed with respect to texture information of the two-dimensional plane.

In addition, for example, angle information may be encoded in accordance with an entropy coding scheme. Accordingly, an entropy coding scheme may possibly be applied to angle information. Therefore, a code amount of angle information may possibly be reduced.

In addition, for example, angle information may indicate one or more angles based on one or more predicted angles predicted for the one or more angles by reference to previously encoded information and one or more prediction errors between the one or more angles. Accordingly, angle information indicating one or more angles based on one or more prediction errors may possibly be encoded. Each of the one or more prediction errors may possibly be smaller than the one or more angles. Therefore, a code amount of angle information may possibly be reduced.

In addition, for example, each of the one or more angles may have a value in a range from 0 degrees to 180 degrees. Accordingly, angle information indicating one or more angles based on a value in a range from 0 degrees to 180 degrees may possibly be encoded. Therefore, an increase in a code amount may possibly be suppressed.

In addition, for example, circuit 151 may select a processing mode for the position of the fourth vertex from a plurality of processing modes including an angle mode. Furthermore, circuit 151 may encode the angle information into the bitstream when the angle mode is selected as the processing mode for the position of the fourth vertex. Accordingly, the processing mode of the position of the fourth vertex may possibly be adaptively selected. Therefore, the position of the fourth vertex may possibly be adaptively processed.

In addition, for example, circuit 151 may select the processing mode for the position of the fourth vertex by reference to a corresponding processing mode for a position of a corresponding vertex that is a vertex corresponding to the fourth vertex on a geometry map of a three-dimensional space. Accordingly, a processing mode suitable for the position of the fourth vertex on the texture map may possibly be selected according to the corresponding processing mode for the position of a corresponding vertex on the geometry map. In addition, an increase in a code amount with respect to the processing mode may possibly be suppressed.

In addition, for example, circuit 151 may encode a flag into a header of the bitstream, the flag indicating whether to select the processing mode for the position of the fourth vertex by reference to the corresponding processing mode for the position of the corresponding vertex. Furthermore, circuit 151 may select the processing mode for the position of the fourth vertex by reference to the corresponding processing mode for the position of the corresponding vertex when the flag indicates that the corresponding processing mode for the position of the corresponding vertex is to be referred to.

Accordingly, whether to select the processing mode for the texture map according to the corresponding processing mode for the geometry map may possibly be switched according to the flag. Therefore, whether to select the processing mode for the texture map according to the corresponding processing mode for the geometry map may possibly be adaptively switched.

In addition, for example, the angle information may indicate the one or more angles based on one or more corresponding angles used for identifying a position of a corresponding vertex that is a vertex corresponding to the fourth vertex on a geometry map of a three-dimensional space. Accordingly, angle information that is shared between the geometry map and the texture map may possibly be encoded. Therefore, an increase in a code amount may possibly be suppressed.

In addition, for example, the angle information may indicate the one or more angles based on one or more errors between the one or more angles and one or more corresponding angles used for identifying a position of a corresponding vertex that is a vertex corresponding to the fourth vertex on a geometry map of a three-dimensional space.

Accordingly, angle information indicating one or more angles based on one or more errors between the geometry map and the texture map may possibly be encoded. Each of the one or more errors may possibly be smaller than the one or more angles. Therefore, a code amount of angle information may possibly be reduced.

In addition, for example, the one or more angles may be two angles. Accordingly, angle information indicating two angles may possibly be encoded as information used for identifying the position of the fourth vertex. In addition, the position of the fourth vertex may possibly be identified according to only two angles. Therefore, an increase in a code amount may possibly be suppressed.

In addition, for example, the one or more angles may be one angle. Furthermore, circuit 151 may encode distance information indicating a distance between a vertex of the one angle and the fourth vertex.

Accordingly, angle information indicating one angle and distance information indicating a distance may possibly be encoded as information used for identifying the position of the fourth vertex. It can be assumed that the value of the one angle is included in a certain range such as from 0 degrees to 180 degrees. Therefore, an increase in a code amount may possibly be suppressed with respect to one parameter among two parameters used for identifying the position of the fourth vertex.

FIG. 59 is a flow chart illustrating an example of basic decoding processing according to the present embodiment. For example, circuit 251 of decoding device 200 illustrated in FIG. 25 performs the decoding processing illustrated in FIG. 59 in an operation.

Specifically, circuit 251 decodes first vertex information indicating a position of a first vertex of a first triangle, second vertex information indicating a position of a second vertex of the first triangle, and third vertex information indicating a position of a third vertex of the first triangle from a bitstream (S251). In addition, circuit 251 decodes angle information indicating one or more angles used for identifying a position of a fourth vertex of a second triangle by reference to the first triangle from the bitstream (S252). In this case, the second triangle is a triangle which shares a common edge with the first triangle and which is on a same plane as the first triangle.

Accordingly, angle information may possibly be decoded as information used for identifying the position of the fourth vertex. For example, it can be assumed that the value of each angle indicated by the angle information is included in a certain range such as from 0 degrees to 180 degrees. Therefore, an increase in a code amount may possibly be suppressed.

For example, each of the first vertex, the second vertex, the third vertex, and the fourth vertex may be a vertex on a geometry map of a three-dimensional space. Accordingly, angle information used for identifying a position of the fourth vertex of the second triangle by reference to the first triangle that includes the first vertex, the second vertex, and the third vertex on the geometry map of the three-dimensional space may possibly be decoded. Therefore, an increase in a code amount may possibly be suppressed with respect to geometry information of the three-dimensional space.

For example, each of the first vertex, the second vertex, the third vertex, and the fourth vertex may be a vertex on a texture map of a two-dimensional plane. Accordingly, angle information used for identifying a position of the fourth vertex of the second triangle by reference to the first triangle that includes the first vertex, the second vertex, and the third vertex on the texture map of the two-dimensional plane may possibly be decoded. Therefore, an increase in a code amount may possibly be suppressed with respect to texture information of the two-dimensional plane.

In addition, for example, angle information may be decoded in accordance with an entropy coding scheme. Accordingly, an entropy coding scheme may possibly be applied to angle information. Therefore, a code amount of angle information may possibly be reduced.

In addition, for example, angle information may indicate one or more angles based on one or more predicted angles predicted for the one or more angles by reference to previously decoded information and one or more prediction errors between the one or more angles. Accordingly, angle information indicating one or more angles based on one or more prediction errors may possibly be decoded. Each of the one or more prediction errors may possibly be smaller than the one or more angles. Therefore, a code amount of angle information may possibly be reduced.

In addition, for example, each of the one or more angles may have a value in a range from 0 degrees to 180 degrees. Accordingly, angle information indicating one or more angles based on a value in a range from 0 degrees to 180 degrees may possibly be decoded. Therefore, an increase in a code amount may possibly be suppressed.

In addition, for example, circuit 251 may select a processing mode for the position of the fourth vertex from a plurality of processing modes including an angle mode. Furthermore, circuit 251 may decode the angle information from the bitstream when the angle mode is selected as the processing mode for the position of the fourth vertex. Accordingly, the processing mode of the position of the fourth vertex may possibly be adaptively selected. Therefore, the position of the fourth vertex may possibly be adaptively processed.

In addition, for example, circuit 251 may select the processing mode for the position of the fourth vertex by reference to a corresponding processing mode for a position of a corresponding vertex that is a vertex corresponding to the fourth vertex on a geometry map of a three-dimensional space. Accordingly, a processing mode suitable for the position of the fourth vertex on the texture map may possibly be selected according to the corresponding processing mode for the position of a corresponding vertex on the geometry map. In addition, an increase in a code amount with respect to the processing mode may possibly be suppressed.

In addition, for example, circuit 251 may decode a flag from a header of the bitstream, the flag indicating whether to select the processing mode for the position of the fourth vertex by reference to the corresponding processing mode for the position of the corresponding vertex. Furthermore, circuit 251 may select the processing mode for the position of the fourth vertex by reference to the corresponding processing mode for the position of the corresponding vertex when the flag indicates that the corresponding processing mode for the position of the corresponding vertex is to be referred to.

Accordingly, whether to select the processing mode for the texture map according to the corresponding processing mode for the geometry map may possibly be switched according to the flag. Therefore, whether to select the processing mode for the texture map according to the corresponding processing mode for the geometry map may possibly be adaptively switched.

In addition, for example, the angle information may indicate the one or more angles based on one or more corresponding angles used for identifying a position of a corresponding vertex that is a vertex corresponding to the fourth vertex on a geometry map of a three-dimensional space. Accordingly, angle information that is shared between the geometry map and the texture map may possibly be decoded. Therefore, an increase in a code amount may possibly be suppressed.

In addition, for example, the angle information may indicate the one or more angles based on one or more errors between the one or more angles and one or more corresponding angles used for identifying a position of a corresponding vertex that is a vertex corresponding to the fourth vertex on a geometry map of a three-dimensional space.

Accordingly, angle information indicating one or more angles based on one or more errors between the geometry map and the texture map may possibly be decoded. Each of the one or more errors may possibly be smaller than the one or more angles. Therefore, a code amount of angle information may possibly be reduced.

In addition, for example, the one or more angles may be two angles. Accordingly, angle information indicating two angles may possibly be decoded as information used for identifying the position of the fourth vertex. In addition, the position of the fourth vertex may possibly be identified according to only two angles. Therefore, an increase in a code amount may possibly be suppressed.

In addition, for example, the one or more angles may be one angle. Furthermore, circuit 251 may decode distance information indicating a distance between a vertex of the one angle and the fourth vertex.

Accordingly, angle information indicating one angle and distance information indicating a distance may possibly be decoded as information used for identifying the position of the fourth vertex. It can be assumed that the value of the one angle is included in a certain range such as from 0 degrees to 180 degrees. Therefore, an increase in a code amount may possibly be suppressed with respect to one parameter among two parameters used for identifying the position of the fourth vertex.

In addition, for example, the processing mode may correspond to prediction_mode or the like. The angle mode may correspond to only_angles_mode or the like.

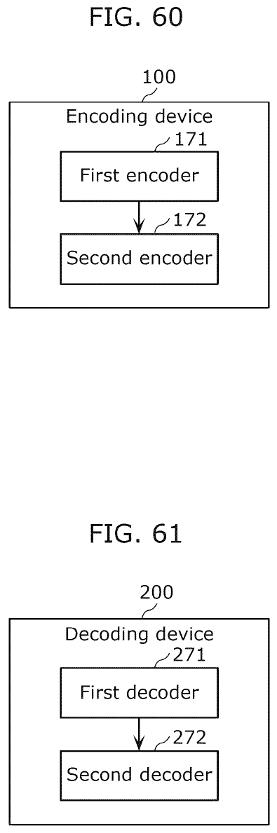

FIG. 60 is a block diagram illustrating yet another configuration example of encoding device 100 according to the present embodiment. In this example, encoding device 100 includes first encoder 171 and second encoder 172.

First encoder 171 is, for example, an electric circuit. First encoder 171 may correspond to vertex information encoder 101, attribute information encoder 103, coordinate encoder 165, and the like described above and may be implemented by circuit 151 and memory 152 described above.

Second encoder 172 is, for example, an electric circuit. Second encoder 172 may correspond to vertex information encoder 101, attribute information encoder 103, angle deriver 163, angle encoder 164, and the like described above and may be implemented by circuit 151 and memory 152 described above.

For example, first encoder 171 encodes first vertex information indicating a position of a first vertex of a first triangle, second vertex information indicating a position of a second vertex of the first triangle, and third vertex information indicating a position of a third vertex of the first triangle. In addition, second encoder 172 encodes angle information indicating one or more angles used for identifying a position of a fourth vertex of a second triangle by reference to the first triangle. In this case, the second triangle is a triangle which shares a common edge with the first triangle and which is on a same plane as the first triangle.

Accordingly, encoding device 100 may be able to encode, in an efficient manner, information used for identifying the position of the fourth vertex. Therefore, encoding device 100 may be able to suppress a code amount.

Note that first encoder 171 or second encoder 172 may encode other pieces of information described above. Alternatively, encoding device 100 may include another encoder which encodes the other pieces of information.

FIG. 61 is a block diagram illustrating yet another configuration example of decoding device 200 according to the present embodiment. In this example, decoding device 200 includes first decoder 271 and second decoder 272.

First decoder 271 is, for example, an electric circuit. First decoder 271 may correspond to vertex information decoder 201, attribute information decoder 203, coordinate decoder 265, and the like described above and may be implemented by circuit 251 and memory 252 described above.

Second decoder 272 is, for example, an electric circuit. Second decoder 272 may correspond to vertex information decoder 201, attribute information decoder 203, angle decoder 263, coordinate deriver 264, and the like described above and may be implemented by circuit 251 and memory 252 described above.

For example, first decoder: 271 decodes first vertex information indicating a position of a first vertex of a first triangle, second vertex information indicating a position of a second vertex of the first triangle, and third vertex information indicating a position of a third vertex of the first triangle. In addition, second decoder 272 decodes angle information indicating one or more angles used for identifying a position of a fourth vertex of a second triangle by reference to the first triangle. In this case, the second triangle is a triangle which shares a common edge with the first triangle and which is on a same plane as the first triangle.

Accordingly, decoding device 200 may be able to decode, in an efficient manner, information used for identifying the position of the fourth vertex. Therefore, decoding device 200 may be able to suppress a code amount.

It should be noted that first decoder 271 or second decoder 272 may decode the other information described above. Alternatively, decoding device 200 may include another decoder that decodes the other information.

### Other Examples

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

In addition, encoding and decoding according to the present disclosure can be applied to encoding and decoding of vertex information indicating a position of a vertex. Note that the encoding and decoding according to the present disclosure is not limited to a vertex on a geometry map and a vertex on a texture map and may be applied to encoding and decoding vertex information indicating position of other vertexes. Furthermore, each processing step according to the present disclosure may be performed as one of a plurality of selectable processing steps.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding device comprising:
memory; and
a circuit accessible to the memory,
wherein in operation, the circuit:
encodes first vertex information, second vertex information, and third vertex information into a bitstream, the first vertex information indicating a position of a first vertex of a first triangle, the second vertex information indicating a position of a second vertex of the first triangle, the third vertex information indicating a position of a third vertex of the first triangle; and
encodes angle information into the bitstream, the angle information indicating one or more angles used for identifying a position of a fourth vertex of a second triangle by reference to the first triangle, the second triangle being a triangle that shares a common side with the first triangle and is on a same plane as the first triangle.

2. The encoding device according to claim 1,
wherein each of the first vertex, the second vertex, the third vertex, and the fourth vertex is a vertex on a geometry map of a three-dimensional space.

3. The encoding device according to claim 1,
wherein each of the first vertex, the second vertex, the third vertex, and the fourth vertex is a vertex on a texture map of a two-dimensional plane.

4. The encoding device according to claim 1,
wherein the angle information is encoded in accordance with an entropy coding scheme.

5. The encoding device according to claim 1,
wherein the angle information indicates the one or more angles, based on one or more prediction errors between the one or more angles and one or more predicted angles predicted for the one or more angles by reference to previously encoded information.

6. The encoding device according to claim 1,
wherein each of the one or more angles has a value in a range from 0 degrees to 180 degrees.

7. The encoding device according to claim 3,
wherein the circuit:
selects a processing mode for the position of the fourth vertex from a plurality of processing modes including an angle mode; and
encodes the angle information into the bitstream when the angle mode is selected as the processing mode for the position of the fourth vertex.

8. The encoding device according to claim 7,
wherein the circuit selects the processing mode for the position of the fourth vertex by reference to a corresponding processing mode for a position of a corresponding vertex that is a vertex corresponding to the fourth vertex on a geometry map of a three-dimensional space.

9. The encoding device according to claim 8,
wherein the circuit:
encodes a flag into a header of the bitstream, the flag indicating whether to select the processing mode for the position of the fourth vertex by reference to the corresponding processing mode for the position of the corresponding vertex; and
selects the processing mode for the position of the fourth vertex by reference to the corresponding processing mode for the position of the corresponding vertex when the flag indicates that the corresponding processing mode for the position of the corresponding vertex is to be referred to.

10. The encoding device according to claim 3,
wherein the angle information indicates the one or more angles, based on one or more corresponding angles used for identifying a position of a corresponding vertex that is a vertex corresponding to the fourth vertex on a geometry map of a three-dimensional space.

11. The encoding device according to claim 3,
wherein the angle information indicates the one or more angles, based on one or more errors between the one or more angles and one or more corresponding angles used for identifying a position of a corresponding vertex that is a vertex corresponding to the fourth vertex on a geometry map of a three-dimensional space.

12. The encoding device according to claim 1,
wherein the one or more angles are two angles.

13. The encoding device according to claim 1,
wherein the one or more angles are one angle, and
the circuit further encodes distance information indicating a distance between a vertex of the one angle and the fourth vertex.

14. A decoding device comprising:
memory; and
a circuit accessible to the memory,
wherein in operation, the circuit:
decodes first vertex information, second vertex information, and third vertex information from a bitstream, the first vertex information indicating a position of a first vertex of a first triangle, the second vertex information indicating a position of a second vertex of the first triangle, the third vertex information indicating a position of a third vertex of the first triangle; and
decodes angle information from the bitstream, the angle information indicating one or more angles used for identifying a position of a fourth vertex of a second triangle by reference to the first triangle, the second triangle being a triangle that shares a common side with the first triangle and is on a same plane as the first triangle.

15. The decoding device according to claim 14,
wherein each of the first vertex, the second vertex, the third vertex, and the fourth vertex is a vertex on a geometry map of a three-dimensional space.

16. The decoding device according to claim 14,
wherein each of the first vertex, the second vertex, the third vertex, and the fourth vertex is a vertex on a texture map of a two-dimensional plane.

17. The decoding device according to claim 14,
wherein the angle information is decoded in accordance with an entropy coding scheme.

18. The decoding device according to claim 14,
wherein the angle information indicates the one or more angles, based on one or more prediction errors between the one or more angles and one or more predicted angles predicted for the one or more angles by reference to previously decoded information.

19. The decoding device according to claim 14,
wherein each of the one or more angles has a value in a range from 0 degrees to 180 degrees.

20. The decoding device according to claim 16,
wherein the circuit:
selects a processing mode for the position of the fourth vertex from a plurality of processing modes including an angle mode; and
decodes the angle information from the bitstream when the angle mode is selected as the processing mode for the position of the fourth vertex.

21. The decoding device according to claim 20,
wherein the circuit selects the processing mode for the position of the fourth vertex by reference to a corresponding processing mode for a position of a corresponding vertex that is a vertex corresponding to the fourth vertex on a geometry map of a three-dimensional space.

22. The decoding device according to claim 21,
wherein the circuit:
decodes a flag from a header of the bitstream, the flag indicating whether to select the processing mode for the position of the fourth vertex by reference to the corresponding processing mode for the position of the corresponding vertex; and
selects the processing mode for the position of the fourth vertex by reference to the corresponding processing mode for the position of the corresponding vertex when the flag indicates that the corresponding processing mode for the position of the corresponding vertex is to be referred to.

23. The decoding device according to claim 16,
wherein the angle information indicates the one or more angles, based on one or more corresponding angles used for identifying a position of a corresponding vertex that is a vertex corresponding to the fourth vertex on a geometry map of a three-dimensional space.

24. The decoding device according to claim 16,
wherein the angle information indicates the one or more angles, based on one or more errors between the one or more angles and one or more corresponding angles used for identifying a position of a corresponding vertex that is a vertex corresponding to the fourth vertex on a geometry map of a three-dimensional space.

25. The decoding device according to claim 14,
wherein the one or more angles are two angles.

26. The decoding device according to claim 14,
wherein the one or more angles are one angle, and
the circuit further decodes distance information indicating a distance between a vertex of the one angle and the fourth vertex.

27. An encoding method comprising:
encoding first vertex information, second vertex information, and third vertex information into a bitstream, the first vertex information indicating a position of a first vertex of a first triangle, the second vertex information indicating a position of a second vertex of the first triangle, the third vertex information indicating a position of a third vertex of the first triangle; and
encoding angle information into the bitstream, the angle information indicating one or more angles used for identifying a position of a fourth vertex of a second triangle by reference to the first triangle, the second triangle being a triangle that shares a common side with the first triangle and is on a same plane as the first triangle.

28. A decoding method comprising:
decoding first vertex information, second vertex information, and third vertex information from a bitstream, the first vertex information indicating a position of a first vertex of a first triangle, the second vertex information indicating a position of a second vertex of the first triangle, the third vertex information indicating a position of a third vertex of the first triangle; and
decoding angle information from the bitstream, the angle information indicating one or more angles used for identifying a position of a fourth vertex of a second triangle by reference to the first triangle, the second triangle being a triangle that shares a common side with the first triangle and is on a same plane as the first triangle.
